(19) United States
(12) Patent Application Publication
(10) Pub. No.: US 2008/0046286 A1
(43) Pub. Date: Feb. 21, 2008

(54) Computer implemented healthcare monitoring, notifying and/or scheduling system

(76) Inventor: Mark J. Halsted, Wyoming, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/823,464

(22) Filed: Jun. 27, 2007

Related U.S. Application Data
(63) Continuation-in-part of application No. 11/522,847, filed on Sep. 18, 2006.
(60) Provisional application No. 60/717,923, filed on Sep. 16, 2005.
(60) Provisional application No. 60/794,993, filed on Apr. 26, 2006.

(51) Int. Cl. G06Q 50/00

(52) U.S. Cl. 705/2

(57) ABSTRACT

A medical information system includes a computer server having access to one or more medical information data stores and operating at least a portion of a medical information monitoring tool, and includes at least one user network interface device operatively coupled for communication with the computer server over a computer network or integrated with the computer server, where the medical information data stores include a plurality of patient medical records; where the system is configured to allow an authorized user to activate, via a graphical user interface operating on the user network interface device, a medical information monitoring profile, where the medical information monitoring profile includes: (a) an identification of one or more medical information data items in the medical information data stores to access, (b) at least one notification trigger upon which one or more parties will be notified, an identity of one or more parties to notify, and (c) one or more notification mechanisms for notifying the one or more parties; where the system is further configured to monitor at least one or more of the medical information data items identified in the medical information monitoring profile; and where the system is further configured to automatically notify the one or more parties identified in the medical information monitoring profile, via the one or more notification mechanisms included in the medical information monitoring profile, in automatic response to the at least one notification trigger being satisfied.

### CROSS REFERENCE TO RELATED APPLICATIONS

The present application is a continuation-in-part of U.S. application Ser. No. 11/522,847, filed Sep. 18, 2006, which claims the benefit from U.S. Provisional Application, Ser. No. 60/717,923, filed Sep. 16, 2005, the entire disclosure of which is incorporated herein by reference, and which also claims the benefit of U.S. Provisional Application, Ser. No. 60/794,993, filed Apr. 26, 2006, the entire disclosure of which is incorporated herein by reference.

### BACKGROUND

Getting the right information to the right person at the right time in the right place and in the right situation-specific context remains a significant and important problem in health care. For instance, the radiologist interpreting a CT scan of a chest may want to know what the patient's pulmonologist thought of the case based on their clinic notes. Particular lab results may be of interest to the radiologist protocolling and interpreting the study. A pathology result from a lesion seen on a prior CT scan of the chest may be of interest. If the patient has lab tests indicating borderline renal function, the radiologist will want to know that information prior to administering intravenous contrast (certain medical literature has shown that radiocontrast agents can cause acute renal failure, otherwise known as contrast nephropathy, especially in patients with pre-existing kidney disease or diabetes). As another example, a clinician wishing to order a CT scan for a patient may not have sufficient information to indicate whether the patient is at unusually high risk of post-radiation complications due to a previous number of medical radiation doses (such as previous CT scans). As another example, a clinician wishing to order an MR scan may not have sufficient information to determine whether the patient to undergo the MR scan has metallic surgically implanted devices and/or foreign bodies containing metal, which may or may not be MR compatible.

Traditionally, these disparate pieces of information have been difficult to gather, despite the presence of electronic databases in health care, in part because databases have not been fully integrated, resulting in information silos. The task of gathering all relevant information in order to make an accurate diagnosis has represented such a large barrier that busy health-care providers may not be able to spend the time required to ensure that they have all relevant information available at the time that diagnostic and therapeutic decisions are made. Another problem with traditional electronic health records is that they often require caregivers actively to log in, search for, and retrieve information relevant to care they are providing, which takes time from actually providing care to patients. The inventor is unaware of any informatics tools that “push” information to caregivers in real time while filtering that information so that it is completely relevant to the particular task the caregiver is performing on a moment to moment basis, and the inventor is unaware of any informatics tools that perform significant meta-analysis of laboratory and other diagnostic test result information in order to add value to these results as they are delivered to caregivers.

Lack of such information access and flow not only wastes time, but also may waste money and degrade care by causing health-care system events, such as surgeries to be delayed. A significant source of such delays is not having critical laboratory and other diagnostic test results in hand at the time that the surgery (or other medical procedure) is scheduled to begin. Surgery suite delays are very expensive to the medical institution, as the room itself, involved personnel, physical resources, patients and families, and downstream resources may all be affected. Many of these resources are very expensive. Due to such delays, caregivers often have to work overtime, bed turnover and planning are less efficient, et cetera.

It will therefore be appreciated that embodiments of the invention described below address many broad needs, including but not limited to: facilitating the establishment and automated monitoring and event notification with respect to many healthcare information systems and other healthcare information resources; facilitating automatic monitoring and notification of healthcare institution risks (such as, but certainly not limited to, radiation exposure risks or contrast nephropathy); and facilitating automatic notification of medical procedure scheduling issues.

### SUMMARY

A computer implemented medical event notification system and method for a healthcare facility is provided. A first aspect of the present invention includes at least one user computer and at least one computer server operatively coupled for communication over a computer network. The computer server operates at least a portion of a medical notification software tool and has access to a patient record database containing a plurality of patient records. The method includes a step of monitoring the plurality of patient records by the medical notification software tool for at least one predetermined event; and includes one or both of the following steps: (a) upon detecting the occurrence of the at least one predetermined event by the medical notification software tool, automatically pushing a notification of the detected predetermined event occurrence to an authorized user of the medical information event notification system; and (b) upon detecting the non-occurrence of the at least one predetermined event by the medical notification software tool in a predetermined window of time, automatically pushing a notification of the detected predetermined event non-occurrence to an authorized user of the medical information event notification system. It is also within the scope of the invention to provide a computer implemented system for implementing such method.

An important element to certain exemplary embodiments of this system and method according to the first aspect of the present invention is that the notification is automatically “pushed” to the authorized user (e.g., the authorized user is emailed the notification, the authorized user is paged with the notification, the authorized user is sent a cellular text message with the notification, and/or the authorized user is sent an electronic instant message with the notification, etc.); that is, the authorized user is not required to query the system for the occurrence or non-occurrence of the event. By automatically pushing the notification to the user, the user only needs (in certain instances) to establish or initially subscribe to the monitoring and can then ‘forget’ about it because the system will automatically send the user the appropriate notification without requiring the user to continuously look for it or continuously query the system.

It is a second aspect of the present invention to provide a computer implemented method for monitoring a healthcare information system. This second aspect includes the steps of: providing a medical information system including a computer server having access to one or more medical information data stores and operating at least a portion of a medical information monitoring tool, and includes at least one user network interface device operatively coupled for communication with the computer server over a computer network or integrated with the computer server, where the medical information data stores includes a plurality of patient medical records; logging into the medical information monitoring tool using a graphical user interface on the at least one user network interface device by an authorized user; activating, by the authorized user via the graphical user interface, a medical information monitoring profile, where the medical information monitoring profile includes: (a) an identification of one or more medical information data items in the medical information data stores to access, (b) at least one notification trigger upon which one or more parties will be notified, (c) an identity of one or more parties to notify, and (d) one or more notification mechanisms for notifying the one or more parties; following the activation step, monitoring by the medical information monitoring tool at least one or more of the medical information data items identified in the medical information monitoring profile; and automatically notifying the one or more parties identified in the medical information monitoring profile, via the one or more notification mechanisms included in the medical information monitoring profile, in automatic response to the at least one notification trigger being satisfied. For the purposes of the present application, a subsequent step or action that occurs “in automatic response to” or “in response to” previous step or action do not necessarily occur in immediate response to the previous step or action. It is within the scope of the limitation that the subsequent step or action occur immediately in the chain of events or further down the line of the change of events, so long as the previous step or action plays a relevant part in the causation or occurrence of the subsequent step or action. The “automatic” term in the limitation adds that the subsequent step is performed automatically by the computerized system without the necessity of human intervention or initiation between the previous and subsequent steps.

It is a third aspect of the present invention to provide a computer implemented method for monitoring a healthcare information system for risks of contrast nephropathy including the steps of: providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records; scheduling a medical procedure involving intravenous contrast for a patient by an authorized user utilizing the at least one user network interface; determining, by the medical information monitoring tool from information accessed in the medical information data stores, a risk for contrast nephropathy with the patient; and automatically transmitting a notification regarding the determined risk to one or more medical system personnel. It is also within the scope of the invention to provide a computer implemented system for implementing such method.

It is a fourth aspect of the present invention to provide a computer implemented method for monitoring a healthcare information system medical procedure schedule including the steps of: providing a medical information system including a computer server having access to one or more medical information data stores and operating at least a portion of a medical information monitoring tool, and including at least one user network interface device operatively coupled for communication with the computer server over a computer network or integrated with the computer server, where the medical information data stores include healthcare institution medical procedure schedules, healthcare institution medical facility availability information, healthcare institution medical equipment availability, healthcare institution medical personnel availability and/or healthcare institution medical test result information; scheduling a medical procedure for the medical institution for a scheduled start time; determining, by the medical information monitoring tool from information accessed in the medical information data stores (a) whether or not the scheduled medical procedure will be likely to start at the scheduled start time, (b) an estimated actual start time for the scheduled medical procedure, and/or (c) at least one factor presently interfering with an ability for the scheduled medical procedure to start at the scheduled start time; and automatically transmitting a notification regarding a result of the determining step to one or more medical system personnel. It is also within the scope of the invention to provide a computer implemented system for implementing such method.

It is a fifth aspect of the present invention to provide a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records; where the system is configured to allow an authorized user to activate, via a graphical user interface operating on the user network interface device, a medical information monitoring profile, the medical information monitoring profile including: (a) an identification of one or more medical information data items in the medical information data stores to access, (b) at least one notification trigger upon which one or more parties will be notified, an identity of one or more parties to notify, and (c) one or more notification mechanisms for notifying the one or more parties; where the system is further configured to monitor at least one or more of the medical information data items identified in the medical information monitoring profile; and where the system is further configured to automatically notify the one or more parties identified in the medical information monitoring profile, via the one or more notification mechanisms included in the medical information monitoring profile, in automatic response to the at least one notification trigger being satisfied.

It is a sixth aspect of the present invention to provide a computer implemented method for monitoring a healthcare information system for risks of implant or foreign body incompatibility with a magnetic resonance scan including the steps of: providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records; scheduling a magnetic resonance scan for a patient by an authorized user utilizing the at least one user network interface; determining, by the medical information monitoring tool from information accessed in the medical information data stores, a risk for implant or foreign body magnetic resonance incompatibility with the patient; and automatically transmitting a notification regarding the determined risk to one or more medical system personnel. It is also within the scope of the invention to provide a computer implemented system for implementing such method.

These and other aspects and advantages of the inventions described herein will become apparent upon reading the following detailed description in reference to the attached drawings.

### BRIEF DESCRIPTION OF THE DRAWINGS

FIG. 1 is a diagram showing an exemplary integration of various databases and hardware.

FIG. 2 is an diagram showing exemplary database integration.

FIG. 3 is a flow chart of an exemplary embodiment of the present invention.

FIG. 4 is a flow chart of an exemplary feature of the present invention.

FIG. 5 is an exemplary search screen according to an exemplary embodiment of the present invention.

FIG. 6 is an exemplary results screen according to an exemplary embodiment of the present invention.

FIG. 7 is an exemplary results screen according to an exemplary embodiment of the present invention.

FIG. 8 is an exemplary subscription screen according to an exemplary embodiment of the present invention.

FIG. 9 is a flow chart of an exemplary feature of the present invention.

FIGS. 10A-D is a set of exemplary log screens according to an exemplary embodiment of the present invention.

FIGS. 11A and 11B are exemplary database object diagrams according to an exemplary embodiment of the present invention.

FIG. 12 is an exemplary email group setup page according to an exemplary embodiment of the present invention.

FIG. 13 is an exemplary electronic message report according to an exemplary embodiment of the present invention.

FIG. 14 is an exemplary communication template according to an exemplary embodiment of the present invention.

FIG. 15 is an exemplary department account setup page according to an exemplary embodiment of the present invention.

FIG. 16 is an exemplary electronic message report according to an exemplary embodiment of the present invention.

FIG. 17 is an exemplary order request page according to an exemplary embodiment of the present invention.

FIG. 18 is an exemplary screen shot of a graphical user interface for selecting or setting up a monitoring and notification profile/macro according to an exemplary embodiment of the present invention.

FIG. 19 is an exemplary monitoring and notification profile/macro according to an exemplary embodiment of the present invention.

FIGS. 20A, 20B, 21, 22, 23 24, 25 and 26 are exemplary graphical user interface menus for setting up portions of the monitoring and notification profiles/macros according to an exemplary embodiment of the present invention.

FIG. 27 is an exemplary graphical user interface menu for setting up notification options for an exemplary magnetic resonance scan compatibility check with respect to a patient's implanted devices or other foreign objects.

### DETAILED DESCRIPTION

Embodiments of the present invention improve the accuracy and efficiency of the everyday tasks of diagnosing, collaborating and scheduling among a plurality of healthcare providers, staff, administrators, patients and family members of patients across a single healthcare system or a network of healthcare systems. To do this, an exemplary embodiment of the present invention utilizes an electronic medical records system, search processes and/or natural language processing models and brokerage of existing electronic mail accounts.

Embodiments of the present invention address the current lack of an easy and automated method for healthcare providers, staff and administrators to “track” future developments and outcomes of particular patient cases. It could be extremely beneficial for an individual physician to have the capability of tracking particular cases in which he or she was professionally involved. For instance, a radiologist may want to know whether her initial interpretation of a mass was accurate; an emergency room physician may wish to find out how a patient he saw and had admitted to the intensive care unit did after leaving the emergency room; a pediatrician may want to follow the progress of her patient while the patient is in the hospital so she is up to speed when the patient returns to her care in the outpatient setting.

In addition to the treating or reviewing physician, other physicians in the same department, practice group or discussion group or may also desire to track the progress of particular cases. For example, the head of a radiology department may want to know whether a report provided by an associate radiologist was accurate; an entire group of physicians treating a single patient may wish to be informed of test results, labs or exam results procured by each other; or a member of a discussion group may be interested in learning the ultimate outcome of a case discussed during a past session. It may also be beneficial for health system administrators to have this tracking capability, by providing increased quality and cost control, malpractice monitoring, and system-wide notification of cases requiring quarantine or other special procedures.

Alternatively, health care providers may find it beneficial to track particular events for a number of patients. For example, the head of the radiology department may wish to be provided with all radiology reports for all ultrasound exams for all patients examined by a department radiologist during a particular period of time. Such event-based tracking capability could also significantly foster education, quality control, malpractice monitoring and the like.

Embodiments of the present invention thus allow a single physician, as well as groups of practitioners, staff and/or administrators to “subscribe” to specific patients. Such subscription would give the individual or group automatic notification of future events and outcomes regarding the selected patient. Alternatively, embodiments of the present invention allow a single physician, as well as groups of practitioners, staff and/or administrators to “subscribe” to specific events regarding a number of patients. The group of patients tracked in this manner may be defined by condition, treating department or physician, age, date of treatment, etc.

Embodiments of the present invention also provide a mechanism to track outcomes which are unexpected, by comparing anticipated diagnoses with actual diagnoses. For instance, a radiologist may not include a final pathologic diagnosis in his initial differential diagnosis. The system would compare the radiologist's report with the final pathologic diagnosis and if there were a significant discrepancy it would alert the radiologist. To accomplish this, as an example, the system may utilize simple search technology or even natural language processing algorithms in combination with expert rules to determine the discrepancies between the diagnoses. If the expert system determines the discrepancies to be of significance, the system would be automatically configured to notify the first physician.

Specifically, in one exemplary embodiment, simple search technology may be used to compare the text of sequential reports for discrepancies. One process to accomplish this is for the system compare the text of an initial report to an expert list of pathologic diagnoses, and identify the diagnosis in the initial report. The system would then search the subsequent report for a matching diagnosis. If the system does not find a matching diagnosis, it would automatically notify the physician who dictated the initial report. Alternatively, the system could simply compare the portions of each report designated by the system as diagnosis segments. If the text of these segments does not match, the initial physician would be notified of the discrepancy.

Yet another exemplary process by which the present invention may accomplish diagnosis comparison is with the use of natural language process models in conjunction one or more sets of expert rules. Specifically, current natural language processing models are capable of extracting the diagnostic terms included in radiologists' reports, such as “Teratoma”, a type of tumor. The invention leverages such an engine to extract the terms offered as potential diagnoses in the original report (the “differential diagnosis”), and compares them to terms appearing in subsequent radiology reports, operative reports, pathology reports, hospital discharge summaries, clinic notes, etc. A suitable natural language processing engine tested for such purposes is the Medical Language Extraction and Encoding System (MedLEE) available through Columbia University. If, for instance, a pathology report specifies a final diagnosis not included in the differential diagnosis of the original radiology report, the system notifies the first radiologist of the discrepancy, offering a link to the original radiology report and to the subsequent pathology report. That radiologist can then re-examine the case and learn from her mistake (in this example, the omission of the actual diagnosis from her original differential diagnosis). Again, subscriptions can be set up to provide such automatic notification to an individual practitioner, a department, a practice group, a discussion group and/or one or more health system administrators.

Furthermore, exemplary embodiments of the system of the present invention will provide a mechanism to alert all prior caregivers, or other designated persons, of interesting and/or rare cases, once they are diagnosed. For instance, if an emergency department physician sees a patient with an unusual constellation of symptoms and findings, that patient is later found to have a very rare condition, the system would notify the emergency department physician of the diagnosis once it is made. To accomplish this, as an example, the system may utilize search technology or natural language processing algorithms in combination with expert rules to monitor for such interesting/rare diagnoses; and if the expert system recognizes the interesting/rare diagnosis, the system could be automatically configured to notify the first department/physician. Additionally, the system could be automatically configured to notify related departments, practice groups, discussion groups or other subscribers. The notification function can also be manually triggered by any caregiver recognizing the case as particularly educational.

Specifically, the natural language processing engine extracts the diagnosis from the reports and compares it to a list of rare conditions. If a final diagnosis, such as indicated in a pathology report, matches one of the list of rare conditions, the system notifies prior caregivers who interpreted diagnostic tests for that case, or other subscriber caregivers, offering them a link to their primary data along with the diagnosis. Those caregivers can then learn better to recognize such a case in the future.

If a caregiver recognizes a case as particularly educational, they can manually trigger similar notification to other caregivers, so that they may benefit from the system-wide data available about the case, again, learning how to recognize similar cases in the future. Group subscriptions may be configured to facilitate notification of established groups of caregivers with specified interests, specialties or educational needs.

Additionally, the system could be used to help alert caregivers of communicable diseases such as pulmonary tuberculosis, once those conditions are diagnosed. This would improve rapid notification of caregivers to seek appropriate testing and therapy themselves, it might help prevent unnecessary transmission of communicable diseases by encouraging rapid, comprehensive, and appropriate isolation of caregivers with whom the patient had had contact. To accomplish this, as an example, the system may utilize natural language processing algorithms in combination with expert rules to monitor for such diagnoses; and if the expert system recognizes the communicable disease diagnosis, the system will be automatically configured to notify all previous caregivers, as well as the health system's administration.

Specifically, similarly to the above, the system extracts diagnoses and compares them to a communicable disease database. A match triggers notification of all caregivers involved, as well as the institutional personnel responsible for containing communicable disease outbreaks and other designated providers, staff and administration. This allows rapid intervention to minimize potential spread of such diseases—such spread is a major public health issue.

Embodiments of the present invention also help caregivers, patients, and authorized family members to ensure that recommended follow-up exams are performed in a timely manner. Specifically, any authorized user can set parameters for recommended exams, lab tests, and follow-up appointments, so that the system notifies the user and/or their designee(s) by email, PDA, cellular, pager, or other technology if any follow-up event is not completed within a specified timeframe.

As an example, if an elderly, debilitated patient in Nebraska is due for an MRI scan to reassess a brain tumor in 3 months, an authorized family-member in New York can log onto the system, and set parameters such that both the family-member and the Nebraska radiology scheduling office will receive an email if no MRI of the brain is performed on the patient between 2 months and 4 months hence. If through cancellations, forgetfulness, transportation problems, or any other issue, the patient's scan is not completed within the 2-4 month timeframe, the system emails the schedulers and the family-member, and they coordinate rescheduling the patient to ensure that the needed exam is completed.

As a further example, if an endocrinologist needs to see a patient back in 3 months with a particular set of lab tests in hand, he can use the system to email his office staff if the labs are not complete one week prior to the appointment date. If the patient fails to complete the labs before then, the staff can contact the patient to get the labs performed, and if necessary reschedule the clinic appointment to give the patient time to have the labs completed. The staff can then fit in another patient and avoid a wasted appointment slot.

Embodiments of the present invention provide an ability to automatically check an ordered test, exam or procedure against a patient's record to identify potential duplication. The system searches a patient's record for similar or matching tests, exams or procedures. A natural language processing model, like those already described, may be used for this function. If a potential duplicate is found, the system automatically sends a message to the ordering user, notifies the user of the potential duplication and asks the user whether he or she still wishes to order the test, exam or procedure. This helps to avoid unnecessary duplicate tests, which can be a major source of waste in the health-care system.

Embodiments of the present invention provide an ability to facilitate easy and efficient follow-up ordering of tests, examinations and procedures. To do this, as an example, such embodiments provide an electronic reporting method that permits the reporting physician to send an electronic report to the ordering physician that includes a recommendation for further testing, examinations and/or procedures in the form of links. The ordering physician need only click on the link or icon associated with a particular test, exam or procedure to order that test, exam or procedure or begin the process of ordering that same test, exam or procedure. The link or icon may direct the physician to a centralized scheduling database, where the physician electronically schedules the test, exam or procedure. Alternatively, activation of such links or icons may simply send a message to the appropriate scheduling personnel that a test, exam or procedure has been ordered and should be scheduled. The staff member receiving the message would then be the one responsible for entering it into the centralized scheduling database. In a third option, the link or icon would lead the ordering physician to an ordering template, whereby the physician could designate the timeframe or other specific criteria relevant to the test, exam or procedure being ordered. The template would then be electronically submitted to the appropriate personnel who would enter it into the scheduling database.

Utilizing such resources, further exemplary embodiments provide the ability for the system to tap into scheduling systems (and/or their associated data stores), laboratory systems (and/or their associated data stores), radiology systems (and/or their associated data stores) and other critical systems (and/or their associated data stores) involved in assisting operating room procedures in starting “on time.” Significant waste in health-care systems occur when critical events such as surgeries are delayed, and a substantial source of such delays is not having critical laboratory and other diagnostic test results in hand at the time that the surgery is scheduled to begin. For example, if a critical laboratory test has not been performed before the surgery is set to begin, the surgery may be delayed.

An exemplary embodiment utilizes the systems and mechanisms provided by the present invention to monitor the relevant health information system databases for requisite events, such as test results, that are required to be performed prior to a medical procedure, such as a surgery. For example, if a sodium test is ordered but is not available at least two hours before the scheduled surgery start time, the system automatically notifies responsible personnel by pager or by some other automatic notification method (such as email, text-message, voice-message, etc). Such personnel are thus given the opportunity to ensure that the requisite sodium test is completed, allowing the operating room procedure to begin on time.

Embodiments of the present invention allow various health-care providers to request any number of requisite events (such as exams, lab tests, facility availability, equipment availability, personnel availability, etc.) to be performed or to occur prior to a procedure (such as a surgery, therapy, treatment, medical test, etc.). The system automatically integrates these requests and uses its notification functionality to notify the responsible personnel (such as the surgeon, the scheduling room, surgical room, etc) of the status of such requests (whether it be a notification that it has not occurred within a given time frame, has occurred and is ready, estimated time of occurrence, etc.) such that the responsible personnel are better able to adjust their schedule or to ensure that the procedure occurs on time or is properly rescheduled so that valuable resources are not wasted.

There are many extensions to such an embodiment. For instance, in radiology, the exemplary system can be set up to provide a notification/alert (via instant message, text message, page, email, desktop Web application, etc) when a combination of the following events is detected by the system: a patient has a lab test result of a poor renal function (such as elevated BUN/creatinine) and the patient is scheduled for a radiology procedure that may require intravenous contrast administration for scans or other tests. The system could be set up such that, when a new test for intravenous contrast is ordered, the system automatically scans the available healthcare information sources associated with the patient to look for pre-existing laboratory data that would suggest that the patient is at risk for renal failure if contrast is administered. This alert allows the health-care provider to contact responsible physicians caring for the patient as soon as possible either to schedule a different exam or to override concern based upon medical necessity. In either scenario, the possibility of harm to the patient is reduced, and the ability of the radiology department to make efficient uses of its resources is maximized.

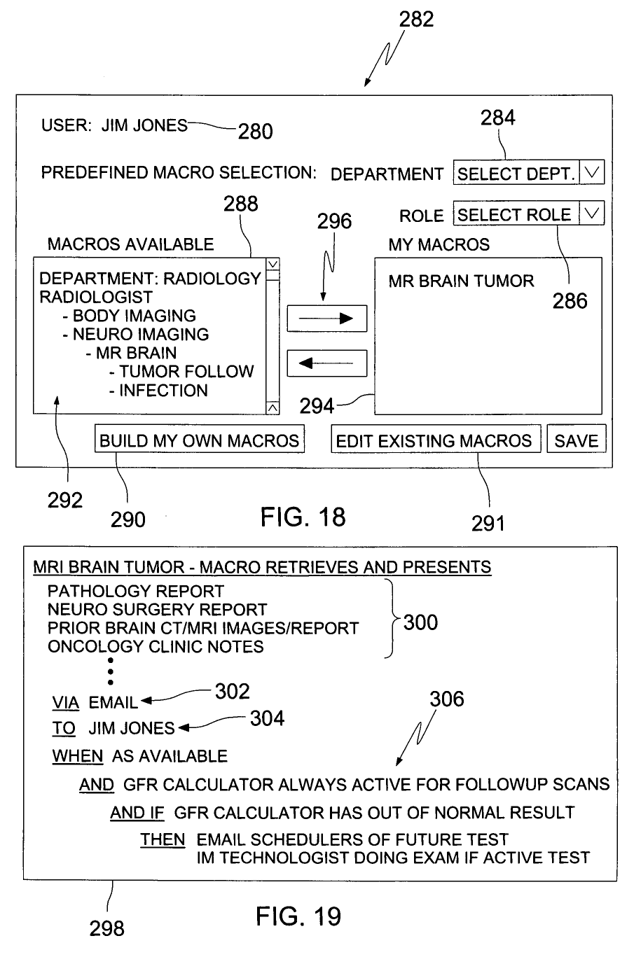

The risk for contrast nephropathy can be calculated on a formula for renal function, based on a known constant that is determined by patient age, height of the patient, and a lab value known as serum creatinine. In patients with moderate to severe renal insufficiency, it is desirable to evaluate for additional conditions that may increase the risk for contrast nephropathy. These additional conditions include diabetes, cardiac disease, heart failure, hypotension, dehydration, diuretic usage, low hemoglobin, low serum albumin, simultaneous use of other medications toxic to the kidneys, and concurrent use of particular medications. In the automatic scan, the system looks for lab values such as BUN and creatinine, automatically alerting the ordering physician (or other personnel) if these values are in excess of a pre-determined threshold (e.g., a “safe” threshold). In addition, the system automatically calculates renal function based on factors described above including patient age, patient height, and creatinine, thereby automatically calculating a Glomerular Filtration Rate, or “GFR,” that is used to determine a risk stratification for the patient's renal function. If the renal function is below a particular threshold (i.e., the patient would be at high risk for renal damage if contrast were given), the ordering physician (or other assigned personnel, such as the physician's nurse or clinical assistant) is notified by pager, PDA, e-mail, etc. (the present application describes many mechanisms for setting up this automatic notification type and destination). There are several exemplary scenarios for such an automatic check to occur, including, but certainly not limited to the following: if a radiology scheduler attempts to schedule a contrast-requiring radiology exam, the system will automatically check the available patient information, calculate a risk strata for the patient, and notify the scheduler (preferably in real time while the scheduler is attempting to schedule the exam) if the patient is at unusually high risk to give the scheduler an opportunity to contact either the ordering physician or a radiologist for approval to proceed; if a radiology front desk staff registers a patient reporting for a scheduled exam involving contrast administration, the system will automatically check the available patient information, and if the patient is at a certain risk level, the system will notify the front desk staff to alert a radiologist who can investigate further; if a radiology technologist checks in a patient to being an exam in which contrast administration is a possibility, the system automatically checks the available patient information, performs the above calculations, and notifies the technologist if the patient is at a pre-determined (high) risk level; if a radiologist requests that contrast be administered while checking an exam, and the technologist requests approval for contrast administration (perhaps including from the pharmacy), the system automatically checks the available patient information, calculates the risk stratification for the patient, and alerts the technologist, radiologist and pharmacist if the patient is at a pre-determined increased risk level; and if a clinician requests contrast administration via an electronic system such as clinical physician online order entry system, the present system automatically checks the available patient information, calculates a risk stratification, and notifies the clinician and/or radiologist and/or other caregiver if the patient is at a predetermined increased risk level. See FIGS. 18-26 and their corresponding discussion below for an example procedure for setting up such an automatic scan, risk calculation and notification “macro” for a caregiver according to an exemplary embodiment of the present invention. It is also within the scope of the invention that the process can be “hard-coded” into the system, that is, the process does not have to be set up by an authorized user—it is preset in some fashion by the software programmer, installer, administrator, etc.

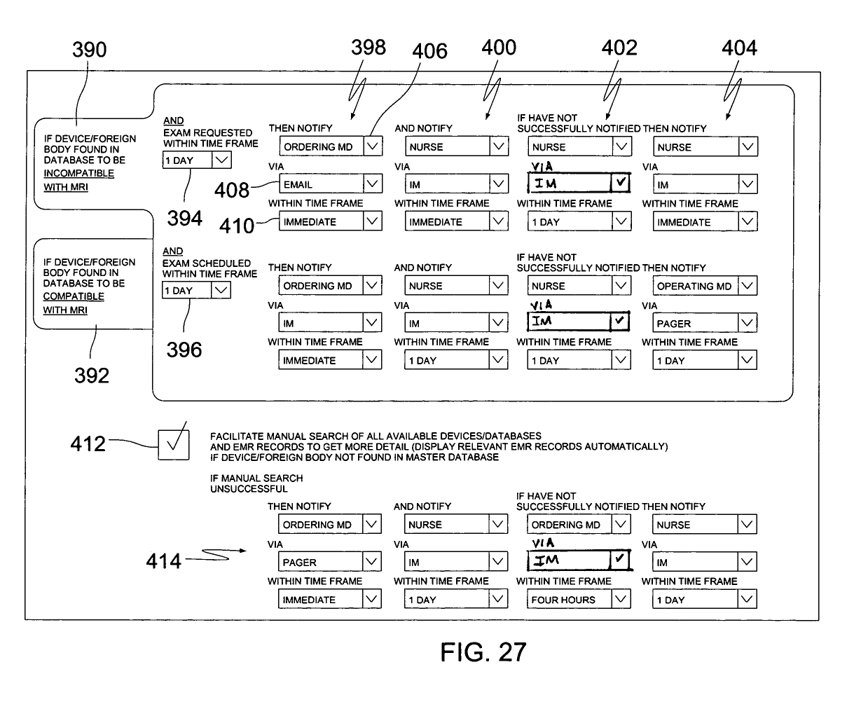

As another exemplary extension to such an embodiment (utilizing any of the exemplary systems, procedures and embodiments described herein), the system can be configured to, upon or during the scheduling of a magnetic resonance (“MR”) scan, automatically query the patient's accessible records to determine whether the patient has any implants or other foreign bodies; and, if so, also automatically check to see whether any of such objects have a risk of not being compatible with the magnetic field to which the patient would be exposed during an MR exam (or any other exam using magnetic fields). If an implanted device or foreign body is not MR compatible and the patient is placed in the MR scanner, there is a risk for tissue burns or damage from dislodgment or movement of the device within the patient. Specifically, this exemplary extension could search, prior to an MR scan (upon, during or even after the scheduling of the scan), all records in the HIS, including clinical notes, surgical notes, pathology reports, radiology dictations, ENT clinic notes, general surgery clinic notes, neurosurgery clinic notes, neurology clinic notes, etc., to identify whether there is a matching term in any of the patient's electronic medical record corresponding to one of the elements in a database of MR compatible and/or incompatible objects/devices (the “Database” or “Master Database” referred to in FIG. 27). If such a match is located, the present embodiment could be configured to present a pop-up alert (or any other type of notification described or contemplated herein) to the authorized user (scheduler, nurse, technologist, radiologist, referring clinician, staff of the referring clinician, etc.) notifying the authorized user that there is a known compatibility status of that device or object, and specifying the status of compatibility of that object or device. FIG. 27, described below, provides an exemplary user interface for establishing such notification options. For instance, if a device is identified as being implanted in the patient through this HIS-wide search, the present embodiment could include in the flag-alert whether or not the recommendation in the database states that the device is MR compatible, whether there is a limit to the magnetic field that can be used with the device, etc. FIGS. 18-26 and their corresponding discussion below also provide an example procedure for setting up such an automatic search, risk determination and notification “macro” for a caregiver according to an exemplary embodiment of the present invention. Such a macro could also be utilized for this MR compatibility check and notification task. It is also within the scope of the invention that the MR compatibility and notification process can be “hard-coded” into the system, that is, the process does not have to be set up by an authorized user—it is preset in some fashion by the software programmer, installer, administrator, etc.

Once the present embodiment has identified that a device is implanted in a patient, it can be configured to automatically search for compatibility information not only locally, within the local databases, but also across the Internet for updated information regarding MR compatibility of that device. Any relevant hits may be returned to the authorized user in real-time, during the scheduling session for example.

This embodiment can be configured to allow a user to search the available resources manually, by entering a search term such as a device name, at any time. This would return all known information about that device, including both the local electronic databases of MR compatibility elements, as well as initiating a broad Internet search, as described above. All relevant information can be immediately returned to the user requesting information for that device.

As another example, the system may be configured to notify (e.g., via pager, email, instant message, cell phone, etc.) involved personnel with accurate timing estimates of specific events. For instance, the surgeon required to arrive in the operating room for the procedure to begin on time could be paged 10 minutes prior to actual procedure start time (or the calculated start time based upon the availability of necessary resources and/or information). This could increase the odds that the surgeon would actually appear in the operating room when the remaining resources were ready to begin. This could help alleviate the greatest cause of operating room start delays—personnel arriving late for procedures. Surgeons tend to arrive late for many procedures because over the years they have become conditioned to the thought that arriving on time will frequently mean that they will need to wait for every other resource to be ready before the procedure can begin, which essentially trains them to show up late for every procedure so they will not have to wait and waste their own time. Because the invention will give the personnel a more accurate indication of the start time, they will be much more likely to arrive at that start time. FIGS. 18-25 and their corresponding discussion below provide an example procedure for setting up an automatic scan, risk calculation and notification “macro” for a caregiver according to an exemplary embodiment of the present invention. Similar graphical user interfaces and macros can be provided for a user to set up a notification for a surgeon (or other personnel) that a surgery (or other procedure) is set to begin at a certain time (in the form of “countdown macros”). To set up these countdown macros, graphical user interfaces may be provided to allow a user to select from the lab test results, exam room, equipment, personnel and/or other hospital resources needed for a given procedure to take place; and will then set up the appropriate notification options. The system will then monitor available information resources and automatically perform the desired notification options when the system determines that the procedure is ready to be performed (or should be ready within a certain time-frame). The system can also be set up to send a notification that the procedure is not ready to occur at a scheduled time based upon the automatic analysis of the hospital resources, and this notification can also include an estimate of the time that this procedure should be ready to take place. It is also within the scope of the invention that the process can be “hard-coded” into the system, that is, the process does not have to be set up by an authorized user—it is preset in some fashion by the software programmer, installer, administrator, etc.

As another example, extended embodiments of the system may be configured to scan across a medical facility's disparate information stores, a regional health information network, and/or other electronic health records, whether regional, national or worldwide, to compile a list of all radiation-based diagnostic tests and therapies experienced by a particular patient or population of patients during their lives or during a particular window of time. The system then calculates from this information risk strata for such patients and/or populations and sends appropriate notifications if the risk strata is within or above a certain predetermined threshold. Such an embodiment addresses the risk of patients (or even caregivers) of eventually developing complications (including cancer) due to long-term radiation exposure associated with medical diagnosis and therapy, even across multiple medical institutions. An embodiment of the system can be configured to perform such an automatic analysis of a patient's lifetime radiation exposure upon the scheduling of any radiation-based diagnostic test or therapy. Utilizing state-of-the-art risk calculation technology, the embodiment automatically estimates the cumulative lifetime dose of radiation to various body parts, translates this into a best assessment of risk of an eventual complication, and reports this in real-time (within a few minutes or even a few seconds or faster) to the scheduler, the physician or some other appropriate party if the calculated risk is within or above a predetermined risk threshold (or regardless of the level of risk). Upon receiving such notice, the caregiver can decide, for example, whether or not the test or therapy is a necessary risk (e.g., if the risk is high, the caregiver can change an order from a CT scan to an MR or ultrasound scan when appropriate). It is also within the scope of the invention that this functionality can be accessible to the patient (or a family member) and the notifications provided on a PDA, cell-phone, laptop or other networked device operated by the patient or family member. This can help the patients manage their own medical care, and more accurately assess the risk and benefit ratio of proposed tests and therapies, in consultation with healthcare providers. It is also within the scope of the invention that radiation researchers can utilize the system to search across exposure profiles for populations of patients, and correlate these data to outcomes data regarding post-radiation tumors and other complications. This tool would improve the ability for such researchers to assess the risk of radiation exposure in the course of medical diagnosis and treatment, and allow regulators to issue more appropriate guidelines and recommendations for radiation exposure limits. As new information is learned from such research activities, the algorithms underlying the present invention can be updated via push technology across the Internet, so that risk stratification reports are as accurate as possible, based on the present status of medical knowledge as it is updated. Individual systems and devices running the software would thus be kept up-to-date with the most recent information available.

Exemplary embodiments include a networked computer system which includes software that provides a simple user interface for physicians, departments, practice groups, discussion groups, staff and/or health system administration to identify a specific patient to track. The networked computer system also allows a user to select which parts of the medical record the physician would like the system to monitor; for instance, radiology reports, surgery reports, pathology reports, discharge summaries, etc. The system then automatically monitors those portions of that patient's electronic medical record, and when a new event occurs in one of the areas the user has marked as “track” (such as a new radiology report), the system automatically generates and sends a message (such as an e-mail) alerting the user that the new event has occurred, and provides at least a portion of the report content from that new event (such as a radiology report text and images).

The system also automatically tracks all reports for discrepancies, such as a radiology dictation that does not mention the final diagnosis of a subsequent pathology report, and notifies users of these discrepancies—for instance, emailing the radiologist who omitted the final diagnosis from his report.

All notification requests, email communications and order requisitions are automatically logged into a central audit database. This promotes regulatory, administrative and risk and cost management. Additionally, data encryption and/or firewall security measures are used to protect all information and communications managed by the system.

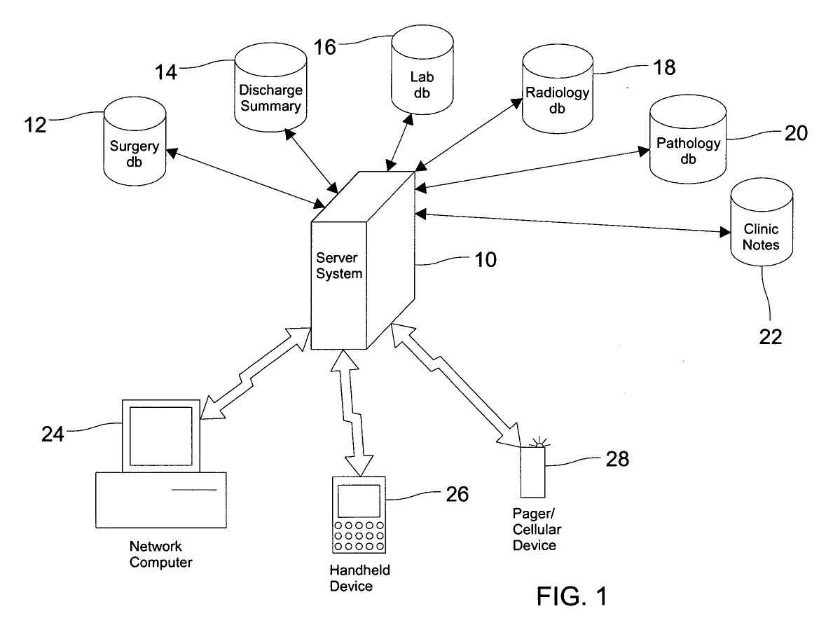

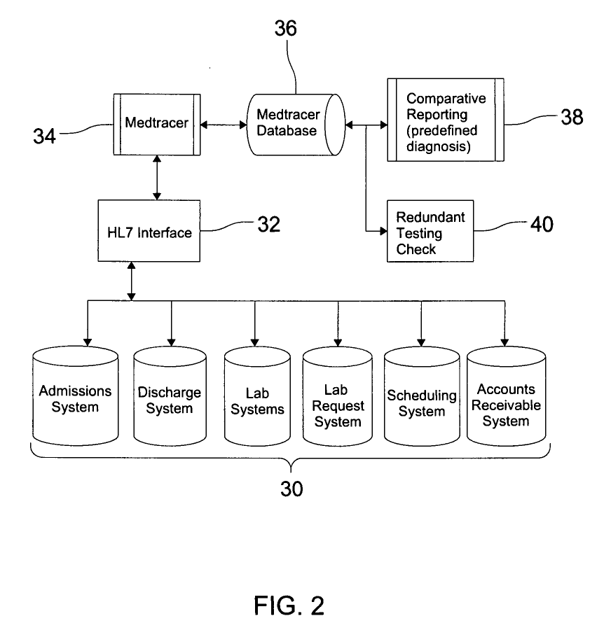

As shown in FIG. 1, the exemplary system is housed on a server 10 that queries a hospital's information systems and databases such as the surgery database 12, the discharge summary database 14, the laboratory (testing) database 16, the radiology database 18, the pathology database 20 and the clinic notes database 22. The system communicates with the physicians and other professionals and staff who are utilizing the system over networked communication devices such as (and without limitation) a networked computer 24, a handheld device (such as a PDA) 26, or a pager/cellular device 28. The computer network can be any type of computer or electronic network such as (without limitation) an intranet, the world-wide-web, another type of global-access data network or a cellular network. As shown in FIG. 2, the exemplary system 34 pulls information from various discrete databases and other sources 30, and pushes this information to a system user according to the user's defined subscription or tracer. A translation interface, such as the HL7 Interface 32, may be used to integrate databases from separate health systems by translating and standardizing the differing terms used by each of the databases. The exemplary system itself may maintain its own database 36 for storing user preferences, tracers, past searches, etc. This database would also facilitate the diagnosis comparison feature 38 and redundant test checking feature 40 already discussed. It should be understood that the server 10 on which the exemplary system is operating (and which may appear in the appended claims) may be a single computer server, a networked group of computer servers, or any other networked computer device or computerized device or system of computer devices or computerized devices on which the information tools of the exemplary embodiments may operate. It is also to be understood that one or more of the networked computer 24, or other interface terminals (such as PDA 26 or cellular device 28 or the like) may also comprise the server 10 or be included with the server system 10.

In this exemplary system, the notification is automatically “pushed” to the user (e.g., the user is emailed the notification, the user is paged with the notification, the user is sent a cellular text message with the notification, and/or the user is sent an electronic instant message with the notification, etc.); that is, the user is not required to query the system for the occurrence or non-occurrence of the event. By automatically pushing the notification to the user, the user only needs (in certain instances) to establish or initially subscribe to the monitoring and can then ‘forget’ about it because the system will automatically send the user the appropriate notification without requiring the user to continuously look for it or continuously query the system

Additionally, the system is capable not only of tracking future results and events for any patient, but it can also allow a user to query back in time for specific records and other information. Specifically, the system provides an interface to filter and select a patient's past reports in real time, returning results relatively instantly to the authorized user, allowing an authorized user to scan through all relevant reports quickly through a single interface. Reports accessible in this way may include radiology, pathology, surgery, clinic notes, discharges summaries, etc. Such an interface saves the user significant time when compared to more traditional search methodology in the health care setting, which usually requires the user to access disconnected information systems with different usernames, passwords, and user interfaces. For any patient, the exemplary system can display all prior results/records or filtered prior results/records from available hospital information systems. For radiology reports, the user can filter by specifying a modality and body part. The user can also specify date ranges to constrain searches.

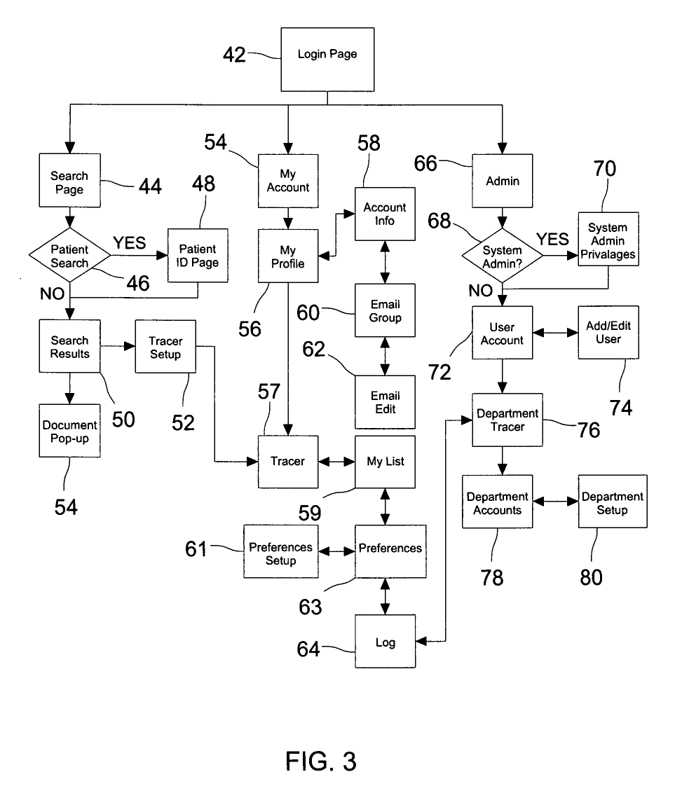

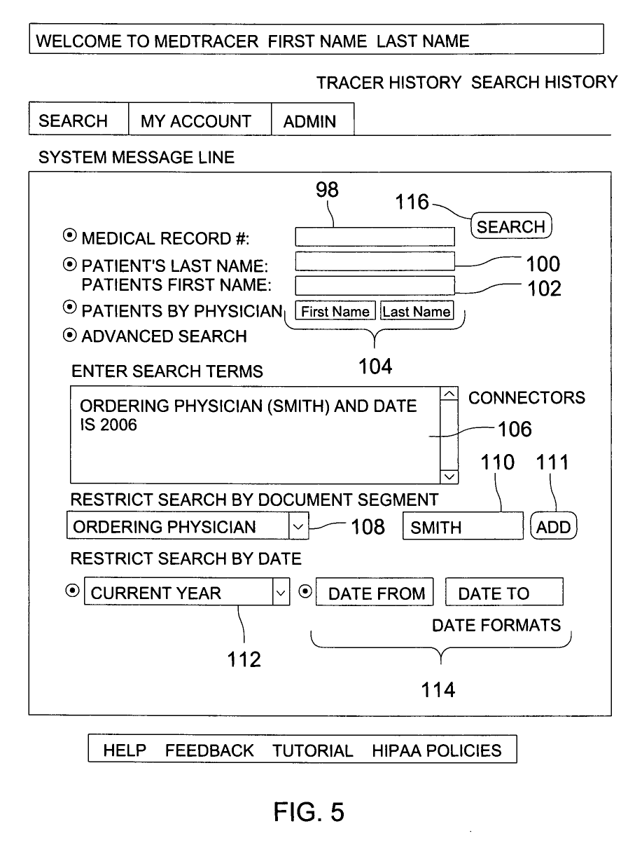

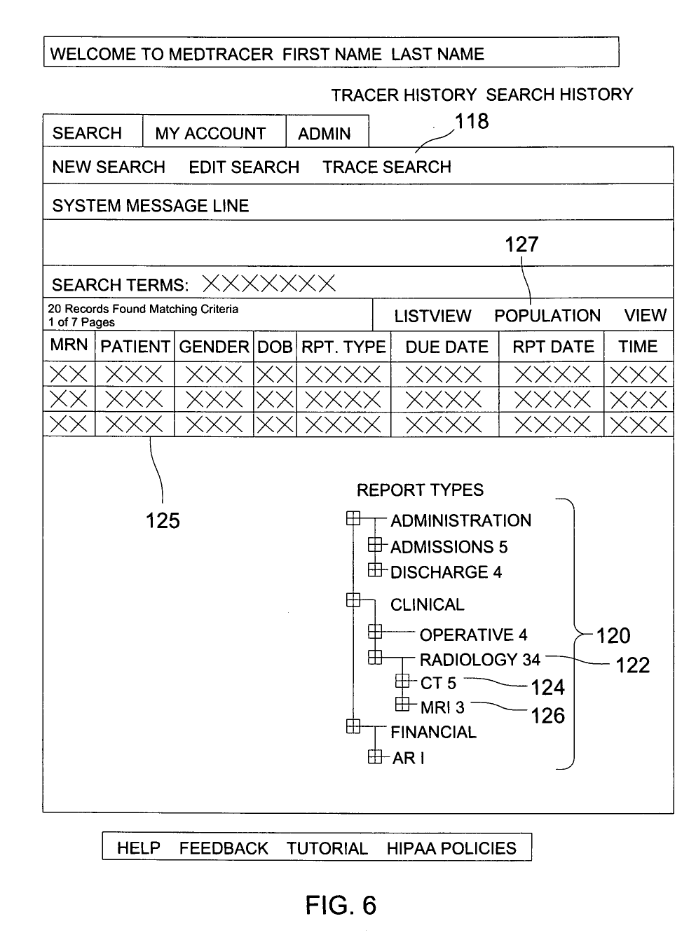

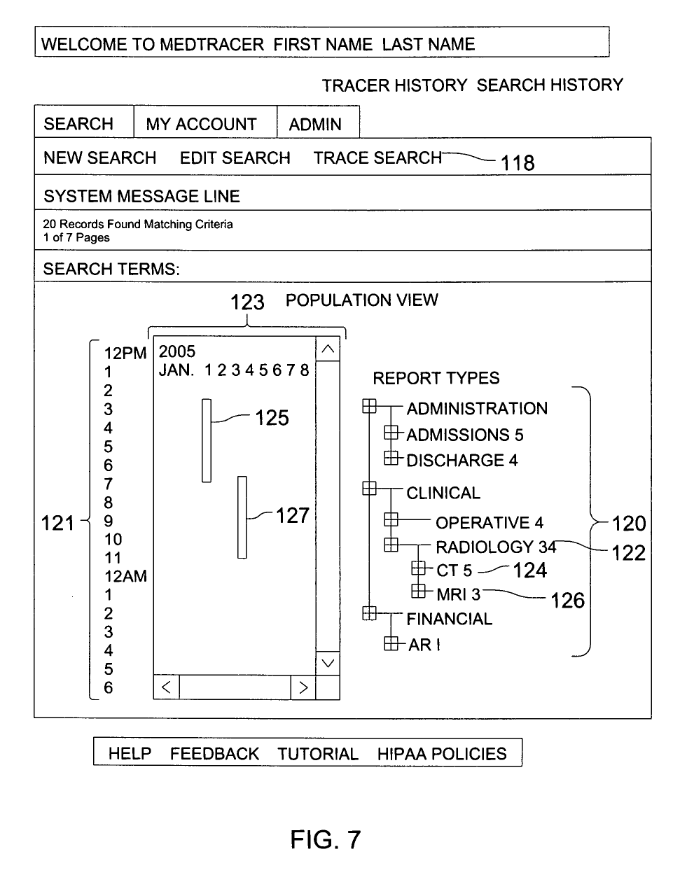

FIG. 3 provides a flow diagram of various exemplary functions of the system that are hereinafter described in detail. Step 42 illustrates the initial Login page for authorizing a user to access the system. As with many secure-access programs, the authorized user may be authorized for all or specific portions of the system, depending upon the user's access status. Upon accessing the system, the user may be taken to or may select one of three initial graphical user interface (GUI) pages as shown in FIG. 3, which includes a “Search” page 44, a “My Account” page 54, and “Admin” page 66. In the Search page 44, which is described in more detail below with respect to FIG. 5, the user will be queried whether or not he or she wishes to conduct a patient search in Step 46. If the user selects a patient search, the user will be taken to a “Patient ID Page” 48 as shown and described below with respect to FIG. 6. The search results are provided in the “Search Results” page 50 as shown in FIG. 7, for example. In the “Search Results” page 50, the user at that point could set up a Tracer Search 52 or request a document(s) from the Patient Record Database 54 as will be discussed in further detail below. Furthermore, the Tracer Set Up 52 and Tracer viewing/editing 57 steps are also described in further detail below.

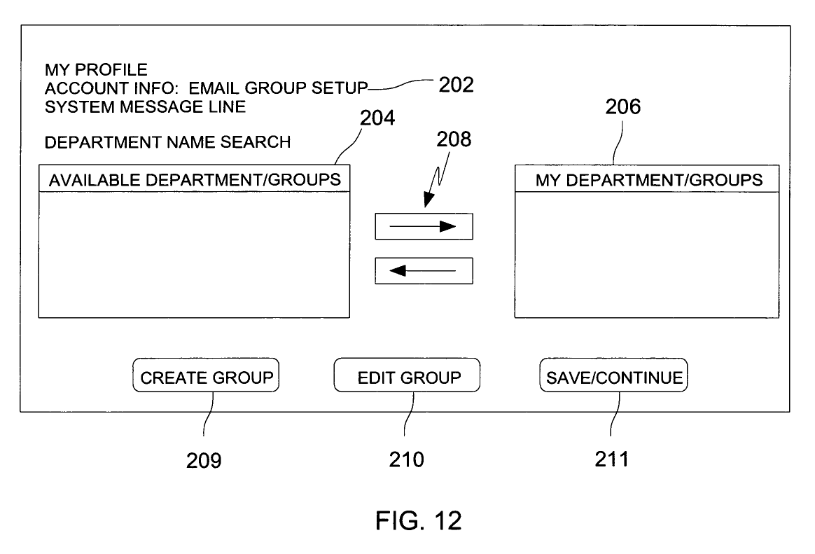

From the “My Account” page 54, the user can go to the “My Profile” page 56. In the “My Profile” page, the user can adjust his or her account information in Step 58, adjust his or her email groups in Step 60, and/or adjust other email options and make edits to emails in Step 62. Examples of these pages and steps are described in further detail below (see FIG. 12 and its corresponding discussion). Further, from the “My Profile” page 56, the user can set up, adjust, or monitor “Tracers” at 57. The user will have a list of established Tracers 59, will have the ability to view 63 and adjust preferences 61 for these Tracer Searches, and will also have the ability to review a log 64 of tracer communications and/or other transactions occurring in the system.

In the “Admin.” page 66, the user will be queried whether or not the user has a system administration status in Step 68. If so, the user is granted system administration privileges 70. Upon determining the administration privileges, the user will be taken to the “User Account” page 72 in which the user can view, add and/or edit the user accounts information 74. From the “User Accounts” page 72, the user can also view the “any department-wide tracers” that have been set up 76. From the “Department Tracers” page, the administrator may also view and/or edit department accounts in the “Department Accounts” page 78 and may set up various aspects of such department accounts in the “Department Set-Up” page 80. Administrator access also allows access to system logs 64.

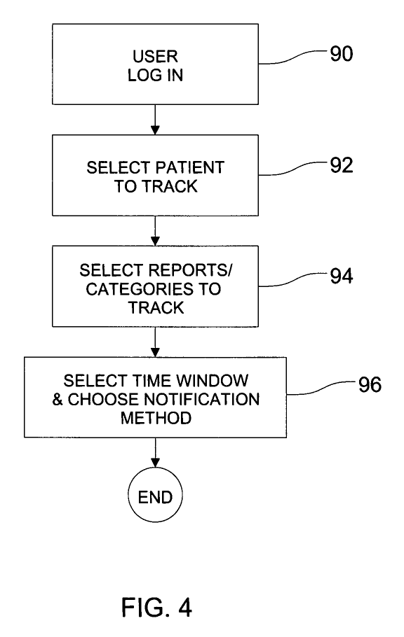

FIG. 4 provides an exemplary flow diagram for establishing a patient record tracking system according to an exemplary embodiment of the present invention. In the first step 90, the user will log on to the system using any known computer-based identification verification method (e.g., username/password) using Login Page 42 of FIG. 3. In the next two steps 92 and 94 the user will select a patient and/or other attribute to track. This may be performed by using Search Page 44. FIG. 5 provides an exemplary screen shot of such a search page. As shown in FIG. 5, the user can enter one or more of a medical record number 98, a patient's last name 100, a patient's first name 102, and/or the name of a physician. Alternatively or additionally, the user may search by entering one or more additional search terms in field 106, connecting such terms using a series of connectors (e.g. Boolean connectors) and/or segment restrictions using fields 108 and 110. Once the search information is entered in the appropriate fields, the search is commenced by clicking “Search” button 116.

FIG. 6 provides an exemplary window in which the system identifies the results that match the physician's search criteria. If more than one patient matches the search criteria, this window will show a number of results 125 matching the criteria entered in the three fields, and the user will be able to select the specific result he wishes to track. The user may choose an alternative view of the results by clicking the “Population View” link 127. The system will then provide the user with a population view as shown in FIG. 7, wherein the results are organized in a two-dimensional layout by corresponding dates 123 and times 121. Such a view will show both the historical results, as well as adding additional results as they are added to any of the integrated databases in real time. The boxes, 125 and 127 will be filled with information specifying the report types that were provided in those specific dates/times, such as “CT Report,” “Lab Report,” etc.

Referring again to FIG. 4, the next step 94 in the process is for the user to select which reports and/or categories to track (for future records) and/or display (for historical records), and/or ensure follow-up. The windows shown in FIGS. 6 and 7 allow the user to filter the results 125 to show only specific reports or categories of reports 120 to track. As can be seen in FIG. 6, the categories of reports with the “+” boxes to the left are capable of being broken into sub categories or specific types of reports. This allows the user to filter results by type, so she sees only reports of interest to her. The “radiology” reports category 122 in this example has been divided into the “CT” sub-category 124 and the “MRI” sub-category 126. It is possible for such sub-categories to be further broken-down into specific exams, tests or procedures. Also, the present invention does not limit the categories of reports to medical reports, as it facilitates tracking of administrative records such as accounts receivable. Such tracers may be especially valuable, for example, for risk management staff to receive administrative and financial reports regarding patients who were not satisfied with their care.

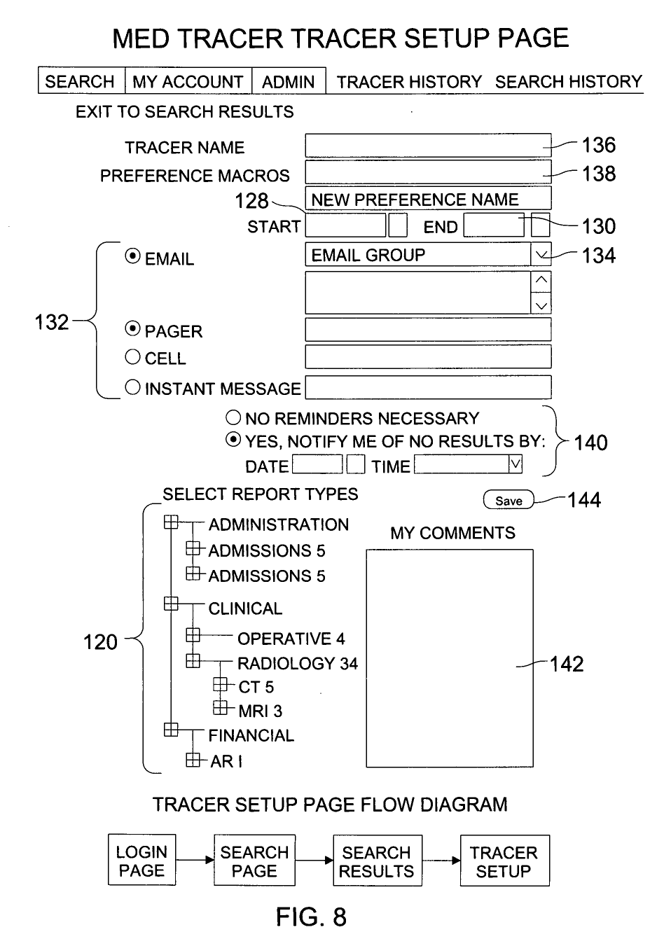

Upon hitting the “Trace Search” button 118 in either of the windows shown in FIG. 6 or 7, the system will advance to step 96 of FIG. 4 (which corresponds to step 52 of FIG. 3) and provide the window as shown in FIG. 8, which allows the user to select a time window for the subsequent tracking to be performed and to choose a notification method(s). Referring to FIG. 8, the window of FIG. 8 includes a listing of the reports and report categories that the user has selected for tracking. In this window, the user is provided with fields 128 and 130 in which the user can then select a window of time in which to track the selected reports, fields 132 in which the user can select the type of messaging methods for notifying the physician of these reports (for example, the physician has selected to be notified by both a pager and by e-mail), and a field 134 in which the user can identify the individual email, email group or email groups to be notified. Additionally the user may name the tracer using field 136 for later reference, choose from a list of pre-set macros from drop-down box 138 (i.e. these may include pre-saved macros established by the user and pertaining to a particular type of exam or report the user tracks often), and/or add comments to the tracer in field 142. Once these fields are updated, the user can activate the tracer by clicking the “Save” button 144. Once activated, the tracer will provide the user (automatically push to the user) with notification, in real time, of events that meet the constraints of the tracer using the notification method chosen.

As discussed above, the system also provides a method for allowing a physician (or another person such as an authorized family member) to ensure that certain events occur. For example, if a physician recommends a follow up exam, the physician can use the system to assure that the follow up exam occurs; or an authorized family member can utilize the system to ensure that another family member's follow up diagnostic test or appointment is completed within an appropriate timeframe.

As another example, when a radiologist recommends a follow-up exam to evaluate a worrisome finding, she wants to ensure that the follow up exam is done. She uses the system to monitor whether the exam is performed in the recommended timeframe: if the exam is not so performed, the system notifies the radiologist, the patient, the scheduling office of the radiology department and/or other responsible departments. The scheduling office contacts the patient so that the patient can be rescheduled for the follow-up exam.

Likewise, the system can be used to ensure that a lab study recommended by an endocrinologist is both performed and that the results are received within a prescribed period of time, so that results are available at the time of a scheduled follow up appointment. As another example, the system can be set up such that, after a scheduling office sets up a test or exam, if the exam is not completed within a set time-frame (for instance, the patient is a no-show or cancels the exam without notifying the office), the system will notify the scheduling office so that another test or exam can be scheduled. The system can also be configured so that patients (and/or patients' families) can monitor care and make sure they follow through in every area where they should by receiving reminders from the system if they fail to complete a given task within a prescribed time frame. As mentioned above, patient proxy, such as son or daughter of an elderly patient, could be granted privileges by the patient to monitor their follow-up remotely, for example, over the world-wide-web (e.g., an elderly patient can be monitored over the Internet by a family member across the country).

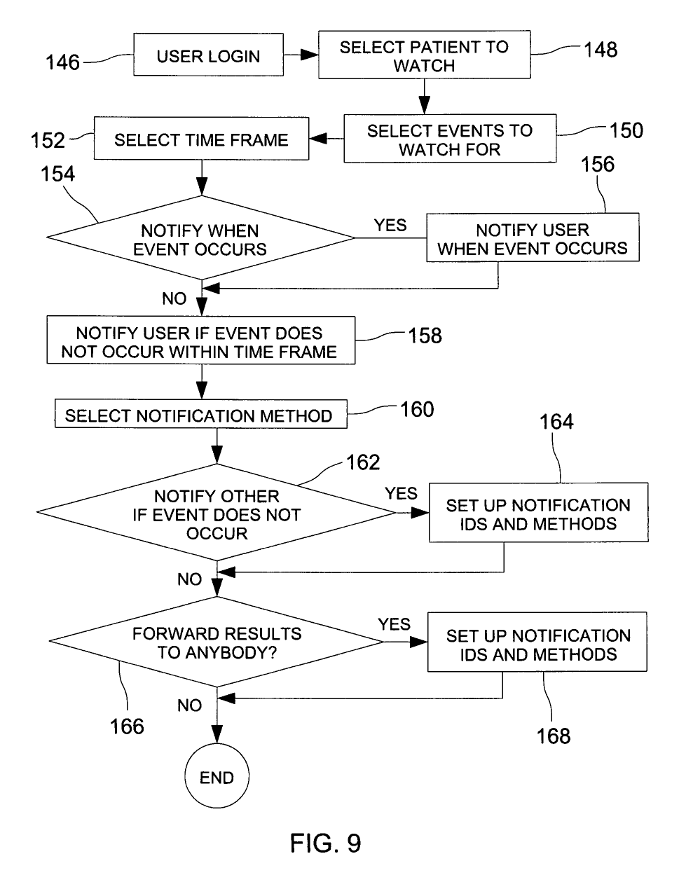

FIG. 9 provides an exemplary flow diagram for setting up such a tracer. The first step 146 involves the user logging into the system similar to the step discussed in step 42 of FIG. 3 and step 90 of FIG. 4. The next step 148 involves a user selecting which patient to watch. This is a similar step as discussed above in step 92 of FIG. 4 and as discussed with respect to FIGS. 5, 6 and 7. In the next step 150 the user selects which events to watch for. This is a similar step as discussed above in step 94 of FIG. 4. In the next step 152, the user selects a timeframe in which to watch such events. In the next step 154, the user selects whether to be notified when the event occurs. If the user wishes to be notified, the system will notify the user when the event occurs as in step 156; and if the user does not wish to be so notified the user will only be notified if the event does not occur within the timeframe as shown in step 158. Thus, if a physician wishes to be paged as soon as a particular test result is available, this step will allow the physician to set up the system to do so. In the next step 160, the user will select a notification method (such as e-mail, pager, telephone, etc.). In the next step 162, the user will be queried whether or not he or she wishes others to be notified if the event does not occur. If others are to be notified, the user is given the ability to set up the notification identifications and notification methods in step 164. In step 166 the user is asked whether or not the system should forward any of the results or reports to any third party. If so, the system will advance to step 168, where the user can set up the notification identifications and methods for notifying such people.

The series of steps described in FIG. 9 may also be performed using the window shown in FIG. 8. In this window, the user may select a particular category such as Radiology, Pathology, Surgery, Lab Results, Clinic Notes or Medication Refill from the list of reports 120. With each selection, the user can, using fields 140, set up a specific timeframe to watch for and select whether or not to be notified with results when the follow up occurs (corresponding to step 158 of FIG. 9). If the user selects no, the user will only be notified if the follow up does not occur. Field 134 may be used to select the notification method, which in this example may be email, pager, instant-message and/or cell phone. This corresponds to step 164 in FIG. 9. In addition to himself, the user may select certain groups of authorized individuals to receive notification by utilizing drop-down menu 134 (corresponding to step 168 of FIG. 9). These third parties can be such as another authorized family member or one or more scheduling offices within the medical facility, one or more outpatient physician offices, etc. Once all of these fields are entered the user will hit the “Save” button 144 to start the process.

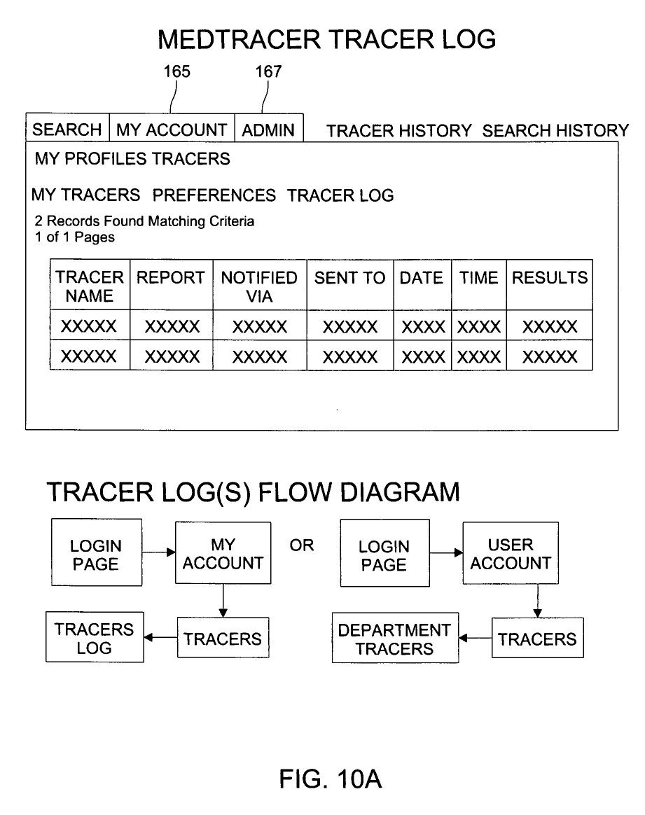

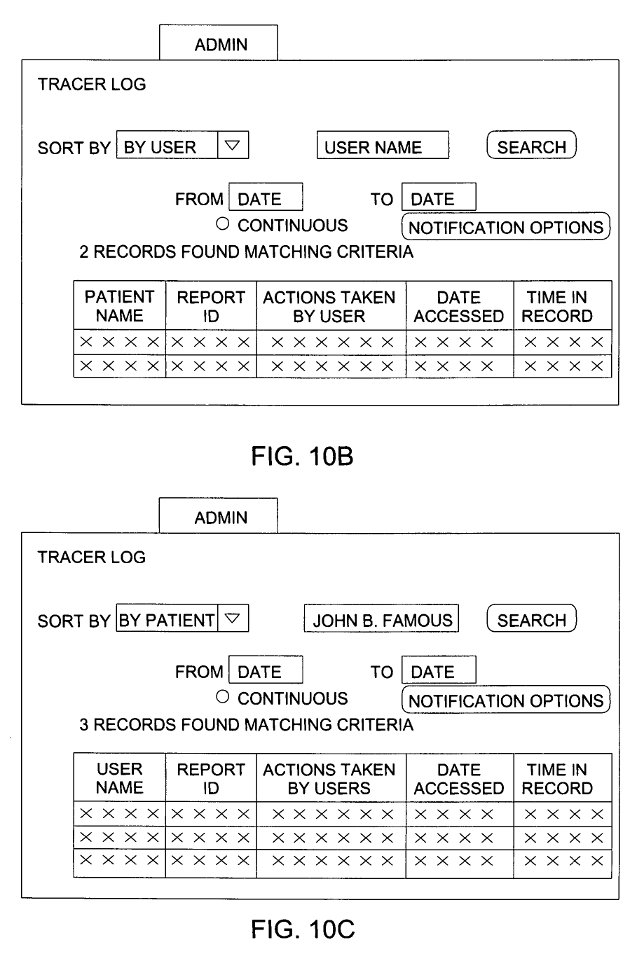

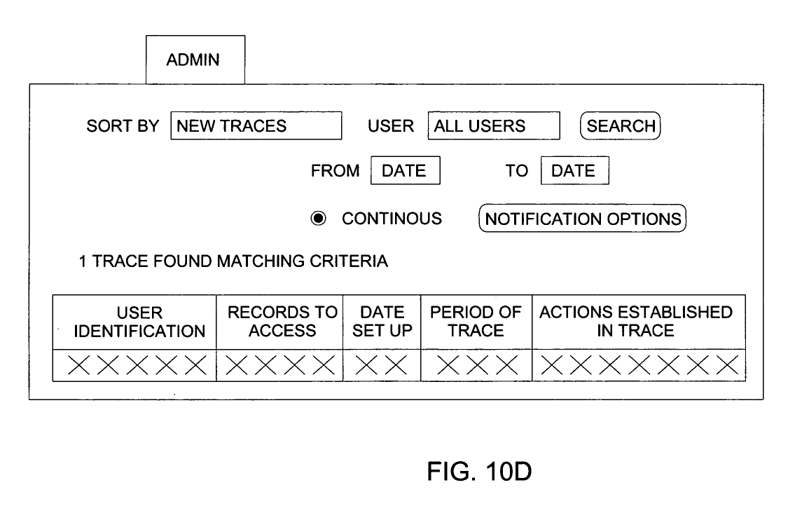

The system of the present invention is also configured to automatically log each and every tracking and watching scenario that is set up and is also configured to log each and every access to patient records. FIG. 10A provides an example of such log. Such logs may be accessed by the individual users (using tab 165), thereby providing such user with a consolidated list of active and/or inactive subscriptions. A log of all use department or even health system wide may be accessible by one or more health system administrators (using tab 167). Such administrative log would be useful to monitor and prevent unauthorized access to patient records. For example, FIG. 10B provides an example of a log in which an administrator can monitor the number of records (or other medical information) accessed by a given user, and FIG. 10C provides an example of a log in which an administrator can monitor the number of accesses that have been made to a certain patient's records by one or more users (to ensure that the privacy of patients, and especially famous or public-figure patients, is protected). For each of these log windows, the administrator can view records accessed previously during a specified period of time and can also enable continuous monitoring and set up notification options so that the administrator will be alerted when the continuous monitoring triggers access to one of the specified records, and/or when new continuous monitoring of patient records is initiated by one or more users. Similarly, FIG. 10D provides an example of a log in which an administrator can monitor for traces that have been set up by other authorized users. Such a log display can report the identity of the user establishing the new trace, the records on which the new trace is established (i.e., which patient records), when the trace was established and for what duration of time the trace was set to monitor the associated records.

As already discussed, another important aspect of the exemplary embodiment of the present invention is that it does not limit the tracking, scheduling and notification functions described above to single physician users. All of these functions may be accessible to groups of physicians, departments, discussion groups, practice groups, staff, health system administrator, patients, family members, etc. For example, by selecting from drop-down box 134 (shown in FIG. 8), a user may choose from a list of groups of individuals, departments, etc. to receive results of a particular subscription. To set up such groups, the exemplary embodiment provides a “My Account” page such as that shown in FIG. 12. This template allows a user to set up multiple groups for email and subscription sharing.

To establish and save a new email group, the user first clicks on the “My Account” tab 165 and is taken to the “My Account” page shown in FIG. 12. Then the user clicks on the “Email Group Setup” tab 202. From here, the user will be provided with a window of available email groups (listed by “Departments” and “Groups” in this example) in window 204, from which the user can select and add to the “My Departments/Groups” window 206 using the add/subtract arrows 208. The set-up window will also have a “Create Group” button 209, which can be activated to allow the user to create a new or custom group of emails (using any type of GUI known to those of skill in the art, not shown); an “Edit Group” button 210, which allows the user to edit an existing group of email addresses (using any type of GUI known to those of skill in the art, not shown); and a “Save/Continue” button 211, in which the user will indicate that the “My Departments/Groups” selection in window 206 is complete.

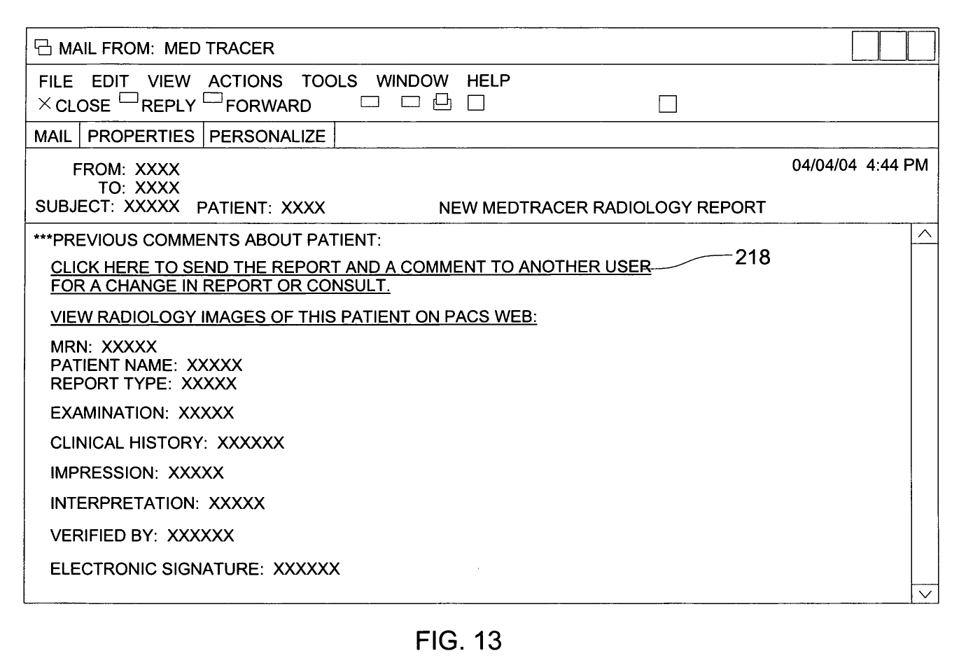

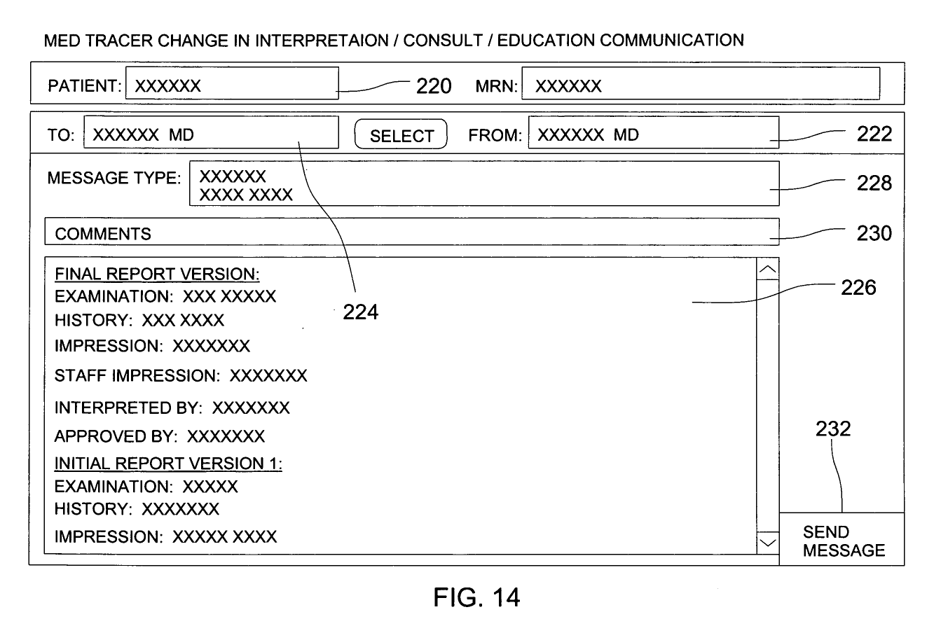

By creating these email-sharing groups (such groups may include interdisciplinary conference members, e.g., neurology/neuro-surgery/radiology conference groups), members of the groups may easily share patient record information, seek second opinions, debate diagnoses or treatment options, etc., thereby fostering increased and efficient collaboration. Such sharing may be done by designating groups of individuals to directly receive the results of a particular subscription using drop-down box in 134 in FIG. 8, as already discussed, or by allowing one user to forward a particular notification to another user or group of users. For example, FIG. 13 shows a tracer notification sent to one physician in the form of an electronic report that includes a link 218. By clicking on this link, the physician is taken to a communication template such as the one shown in FIG. 14. The template displays the name of the patient 220 and the name of the physician 222. Physician 222 then chooses an individual physician or group 224 to forward the report 226. In addition to providing a copy of the report 226, physician 222 may identify the reason 228 he or she is forwarding the report and add comments 230 to accompany the report. By clicking button 232, physician 222 sends the report to the individual group or physician 224, who receives it in the form of an email.

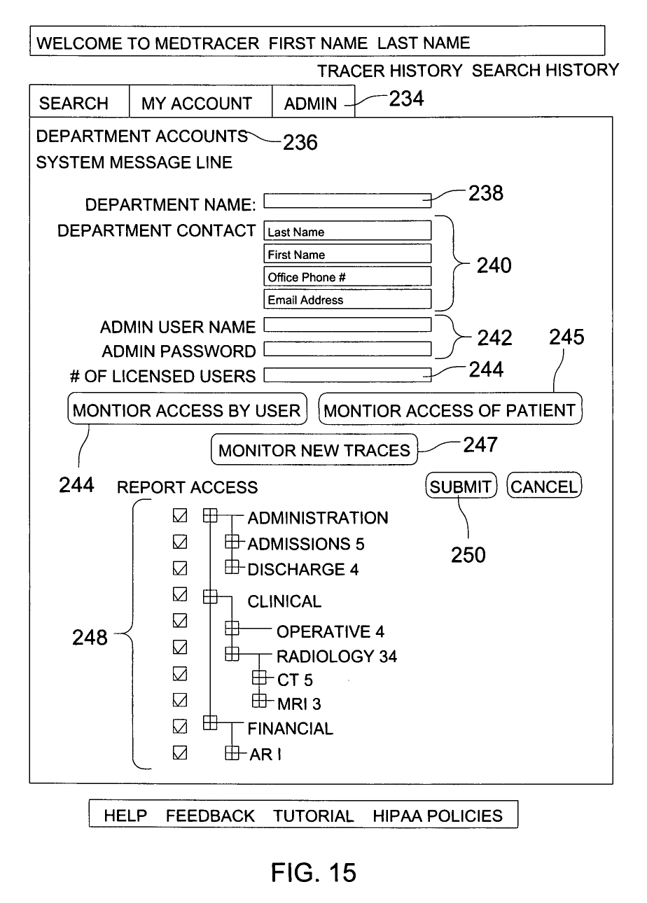

For security and administrative purposes, the exemplary system also allows one or more department or health system administrators to monitor physician and staff access to reports (as discussed above, for example, with respect to FIGS. 10B and 10C). An administrator may set up this function by clicking on the “Admin” tab 234 (FIG. 15), and then “Department Accounts” link 236, which takes the administrator to a page similar to that shown in FIG. 15. From here, the administrator enters the name of the department in field 238, department contact information in fields 240, and the administrator's username and password in fields 242 (for security purposes). Then, selecting whether the administrator wishes to “Monitor Access by User” by activating button 244, or to “Monitor Access of Patient” by activating button 245, or to “Monitor New Traces” by activating button 247, and choosing the categories of records to track from field 248 (optional), the administrator activates the tracer by clicking on the “Submit” button 250. By doing this, the administrator will be taken to screen shown in FIG. 10B if button 244 is activated (monitoring access by a user of the system) or screen shown in FIG. 10C if button 245 is activated (monitoring access to a patient's records on the system) or screen shown in FIG. 10D if button 247 is activated (monitoring new traces) such that a tracer for tracking department access to the selected records is set up and run. With increasing federal and state regulation restricting access to medical records and protecting patient privacy, it is very useful for administrators to have a way to detect any abnormally frequent or uncharacteristic access to patient records within a department. It will be obvious to those of ordinary skill in the art that these monitoring functions can be extended to include, but are not limited to, monitoring patient record access by users at the institutional, regional healthcare organizational, national healthcare organizational, or international healthcare organizational levels.

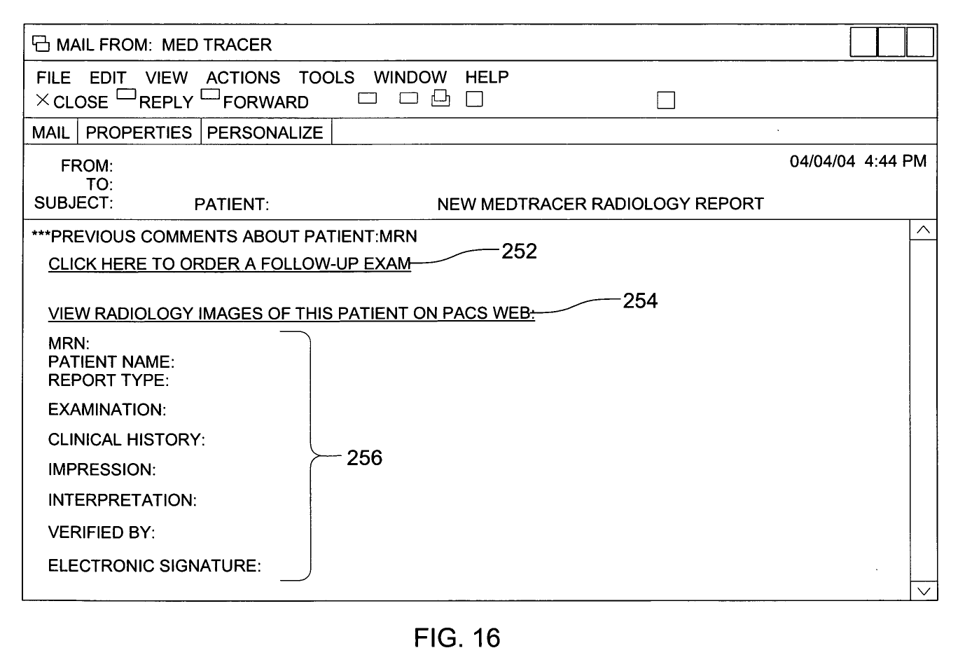

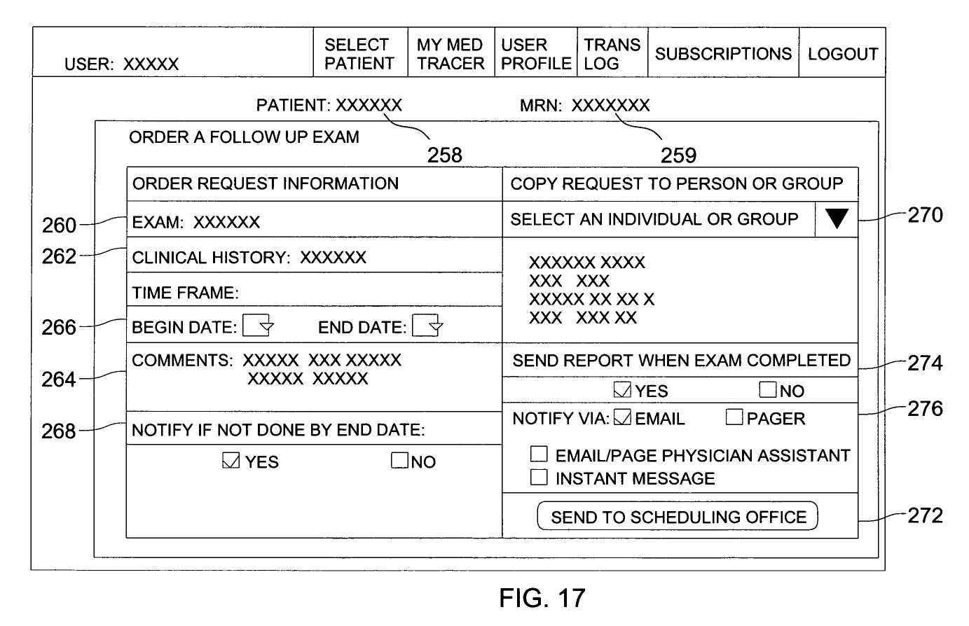

Another important aspect of the exemplary embodiment of the present invention is that it facilitates easy and efficient follow-up ordering of tests, examinations and procedures by integrating an ordering link into an electronic report recommending a follow-up. Such a report is exemplified in FIG. 16. Using the exemplary system, a reporting physician may recommend a follow-up exam in his report 256, which is received by the ordering physician as a tracer notification. By clicking the provided link 252 in the received report, the ordering physician is taken directly to an order template such as that shown in FIG. 17. Such order template could display information such as the patient name 258, MRN 259, the exam requested 260, and a brief clinical history 262. It could also allow the ordering physician to add comments 264 to the order. The ordering physician may then establish a timeframe 266 within which the exam should be completed, checking 268 whether or not he wishes to be notified if the exam is not completed within that timeframe. In addition, the ordering physician may designate other individuals or groups 270 to receive the order requisition. Before sending the order to the appropriate scheduling office by clicking button 272, the ordering physician may specify 274 whether or not he wishes to automatically receive the report when the ordered exam has been completed; and specify 276 the manner in which he will receive such report (such as by email, pager, email/page physician assistant and/or by instant message).

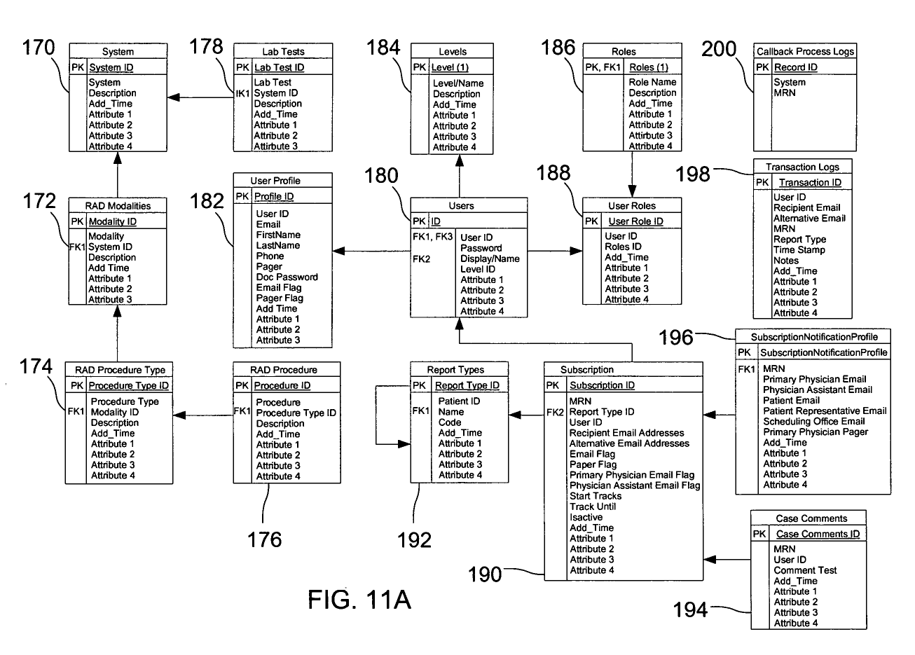

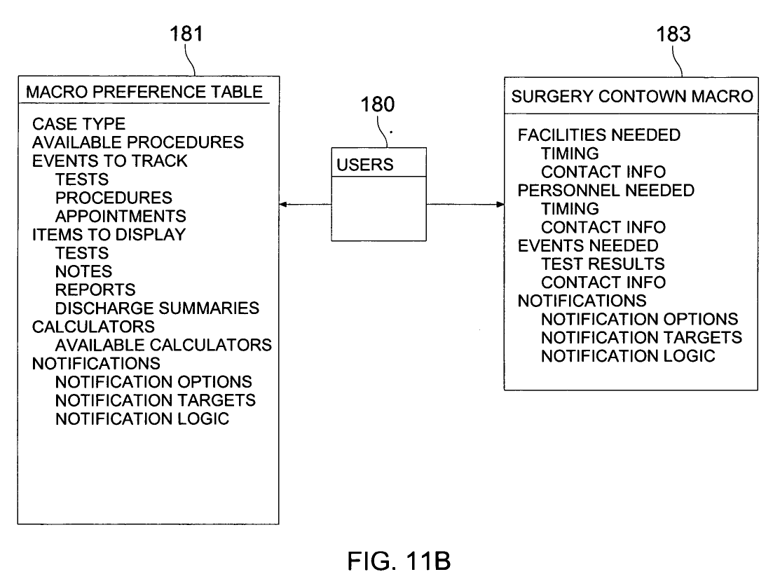

Finally, FIGS. 11A and 11B provide a database object diagram according to an exemplary embodiment of the present invention, that supports the functionality described herein. As shown in FIG. 11A, the “Systems” object 170 includes report types available for the system of the present invention, such as Radiology, Pathology, etc. The “RADModalities” object 172 includes radiology modality names and their descriptions. The “RADProcedureTypes” object 174 includes radiology procedure type names and their descriptions. The “RADProcedures” object 176 includes radiology procedure names and their descriptions. The “LabTests” object 178 includes available laboratory test names and their descriptions. The “Users” object 180 includes user registration and user level information. The “UserProfile” object 182 includes user profile information, e.g., email address, pager number etc. The “Levels” object 184 includes user levels, access privileges/restrictions and level descriptions to support role-based security. The “Roles” object 186 includes user roles, access privileges/restrictions, and role descriptions to support role-based security. The “UserRoles” object 188 maintains a many to many relationship between Users and Roles to support role-based security. The “Subscriptions” object 190 stores patient report subscriptions based on medical record numbers (MRNs) and report types. The “ReportTypes” object 192 stores the hierarchical structure of report types. The “CaseComments” object 194 stores user comments about patient reports—used by caregivers to remind themselves what interests them about a particular case or to communicate with other users about cases. The “SubscriptionNotificationProfile” object 196 is used to support additional notification methods. The “TransactionLogs” object 198 is the log book for email and pager transactions. The “CallbackProcessLogs” 200 is a log book for callback processes. As shown in FIG. 11B, the “Macro Preference Table” object 181 includes macro information set up by and/or selected by the user, which will be described below, and the “Surgery Countdown Macro” object 183 includes macro information set up by and/or selected by the user for the surgery “countdown” processes described herein.

As discussed above with respect to FIGS. 1 and 2, an exemplary system 34 pulls information from disparate discrete databases (12, 14, 16, 18, 20, 22) and other sources 30 according to the user's defined subscription or tracer. A translation interface, such as the HL7 Interface 32, may be used to integrate databases from separate health systems by translating and standardizing the differing terms used by each of the databases and data sources. The value of this functionality can be expanded further.

Getting the right information to the right person at the right time in the right place and in the right clinical context remains a problem in health care. For example, a radiologist interpreting a CT scan of the chest may want to know what the patient's pulmonologist thought of the case based on their clinic notes. Particular lab results may be of interest to the radiologist protocolling and interpreting the study. A pathology result from a lesion seen on a prior CT scan of the chest may be of interest.

Thus expanded embodiments of the present invention utilize the functionality of embodiments described above to provide an electronic network-based (e.g., Web-based) system that is able to pull disparate information from health information systems in real time according to pre-set profiles (also referred to as “macros” below) that may be user and/or role based. Utilizing this expanded embodiment, a health-care provider can specify what pieces of information they would like to have available at the time they make a diagnosis or perform a therapeutic procedure. Thereafter, when the procedure is to be performed by the provider, the expanded embodiment of the present invention automatically pulls available relevant information and presents it to the health care provider in an easily interpreted format. In a more detailed embodiment, where information desired by the health-care provider is not available on the health information database, the system notifies the health-care provider of that fact so that the provider does not waste time seeking information that is not present or not available.

FIGS. 18-25 provide illustrations of an exemplary process for setting up such pre-set profiles or macros by a user of the exemplary system. As shown in FIG. 18, a user 280 of the system will log on to the Graphical User Interface 282 to select and/or define macros for pulling the patient and facility information from the available health information systems in preparation for a predefined process, such as a diagnosis for a therapeutic procedure. The Graphical User Interface 282, in this example, will include pull down menus for the user to select a department 284 and a roll 286 of the user. Once selected, the Graphical User Interface will provide a menu of pre-set macros 288 for selection by the user, a button 290 that the user can activate for building his or her own custom macros and/or a button 291 that the user can activate for editing an existing macro. The predefined macro selection menu 288 includes a list of pre-set macros 292 from which the user can select and transfer into the “my macros” window 294 using the add/subtract arrows 296, the operation of which will be well known to those of ordinary skill in the art.

FIG. 19 illustrates an example of such a predefined macro 298. This predefined macro includes a list of the information resources 300 (such as pathology reports, neurosurgery reports, prior brain CT/MRI images/reports, oncology clinic notes, and the like) from which to pull from the available information systems. The macro 298 will also include the method 302 (such as email, page, instant message (“IM”), download by user) with which to transmit such information, and the destination of address 304 for such information. Finally, the macro will include logic 306 to define when the information should be transmitted and to define certain tests for utilizing numeric calculators, pre-cut analyzers, triggers (such as warning triggers) and follow-up events (such as specifying follow-up tests).

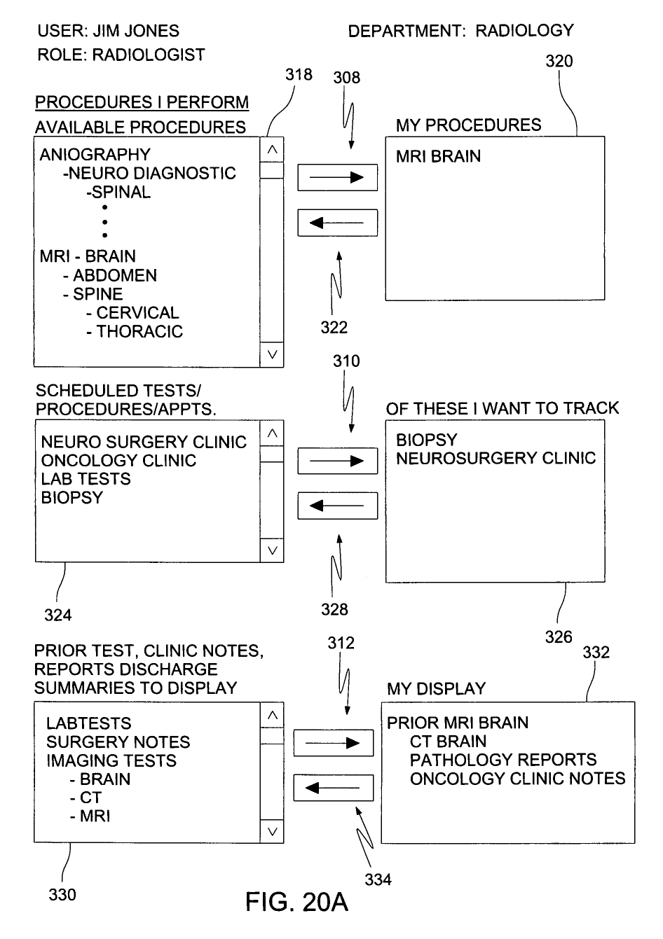

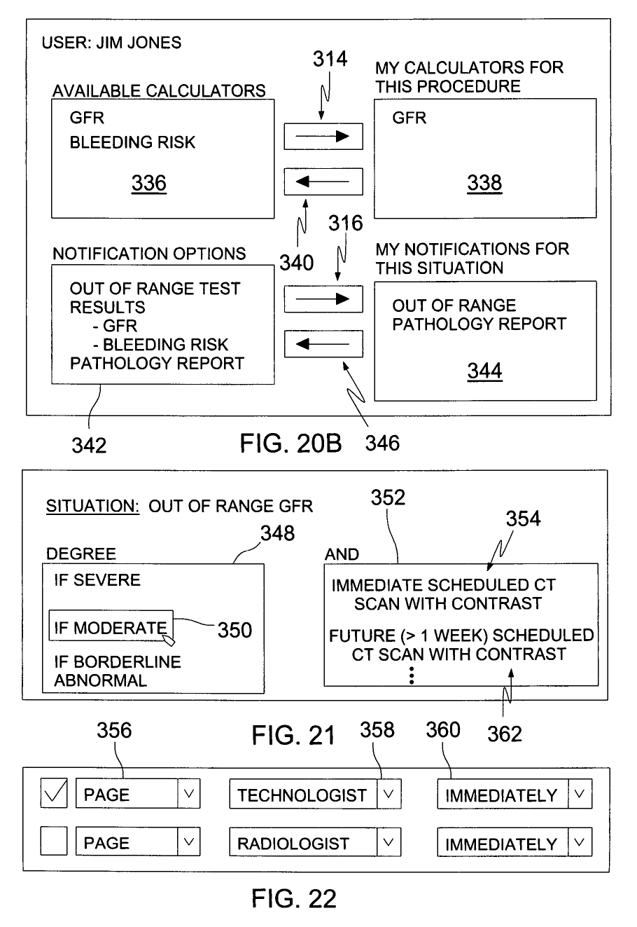

FIGS. 20A and 20B illustrate a Graphical User Interface Wizard that allows the user to customize and configure macros to his or her preferences upon the activation of button 290 in FIG. 18. The Wizard includes designated available procedures that the caregiver may perform within his or her range of expertise through a Procedures Wizard 308; identifies and selects scheduled tests/procedures/appointment types based upon the caregiver's range of expertise in Wizard 310; identifies and selects from all prior tests available via the HIS/EMR/HER including all clinical notes, discharge summaries, test reports, (e.g. pathology, surgery notes, etc.) for the caregiver's range of expertise in Wizard 312; identifies and selects all available calculators that may manipulate and provide added value to the raw data available from the previous wizards and other information sources, including numeric calculators (for example, as discussed above, for a patient to receive CT with contrast, the system can calculate GFR from patient height and creatinine and can send a notification if the resulting calculation is outside of a desired range or threshold) as well as free-text analyzers, including a natural language processing engine and structured reporting analysis engines in Wizard 314; and provides notification options and logic for such calculators in Wizard 316. Although not all wizards can be shown, such free-text analysis enables users to set up many types of checks of reports, and to specify that such checks and analyses be coupled with appropriate provider-, user-, patient-, payor-, proxy- and other notification options based upon the results of such free-text analysis and other meta-analysis of health record data (including but not limited to test result data). For example, free-text analysis can be used to check whether a radiology report does not include a particular diagnosis, and if not, the proper party can be notified. Similarly, free-text analysis can be used to determine whether any particular analysis and/or report does not include the ultimately proven final diagnosis, and if it does not, the proper party can be notified.

In FIG. 21, another GUI Wizard provides a list for selection from all test types that the caregiver may order with a corresponding future result watch which may include a menu of out of range test result warning triggers (e.g. creatinine above 2.0, above 2.5, etc.), a menu of triggers that specify how quickly each test type must be completed, which will include time frames, whom to warn, method to warn (e-mail, pager, PDA, etc.), and a menu of follow-up tests to offer when presenting new test results (for example, full electrolyte panel after delivering sodium result, or MRI of knee after ordering x-rays).

The Available Procedures Selection Wizard 308 shown in FIG. 20A provides a first menu 318 listing procedures performed by the caregiver within the caregiver's range of expertise. The user can highlight and select from such available procedures to be transferred into the “My Procedures” window 320 using add/subtract arrow actuators 322.

Similarly, Wizard 310 provides a menu 324 listing scheduled tests/procedures/appointment types for the caregiver's range of expertise from which the user can select and transfer into the “of these I want to track window” 326 using add/subtract arrows 328. Likewise, Wizard 312 provides a menu 330 listing all prior tests available via the HIS/EMR/HER including all clinical notes, discharge summaries, test reports used by the caregiver within the caregiver's range of expertise from which the caregiver can highlight and transfer into the “My Display” window 332 using the add/subtract arrows 334.

Referring to FIG. 20B the next Wizard 314 provides a menu 336 of available calculators used in the caregiver's range of expertise, as well as free-text analyzers, including natural language processing engines and structured report analyzes engines that may be used within the caregiver's range of expertise. From this menu 336 the user can select and place into his “My Calculators for This Procedure” window 338 using add/subtract arrows 340.

Finally, Wizard 316 provides a menu 342 of notification options, such as “out of normal range” warning triggers, time frame triggers, and follow-up tests that may be utilized by the caregiver within his or her range of expertise. These notification options and triggers can be selected and transferred into the “My Notifications For This Situation” window 344 using add/subtract arrows 346.

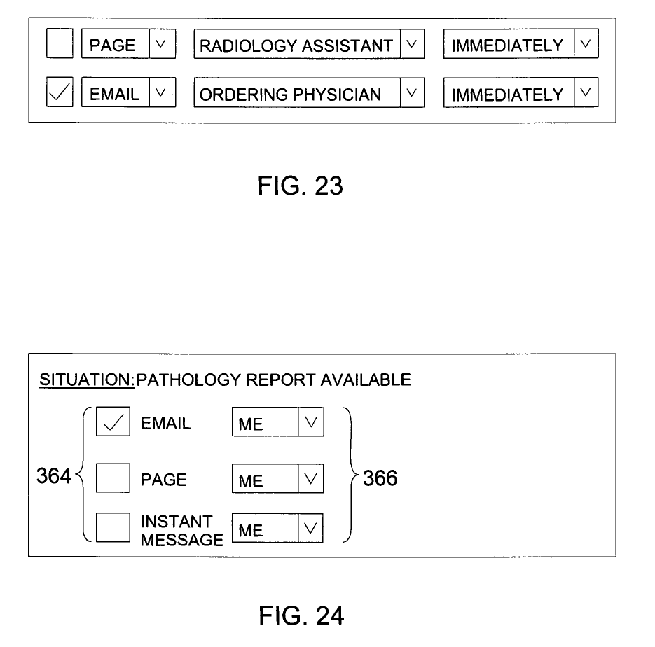

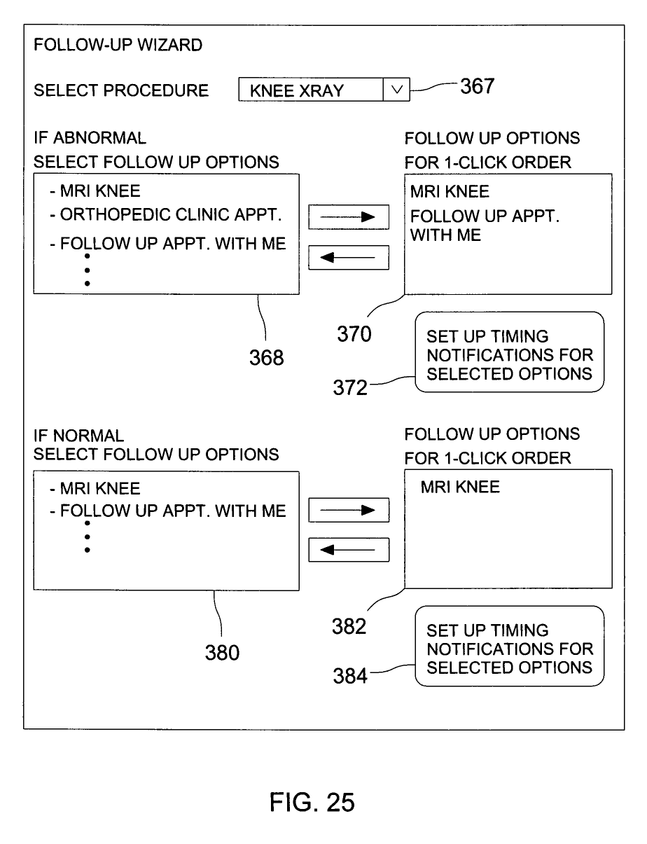

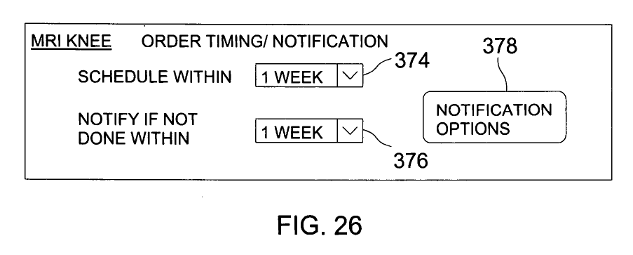

FIG. 21 provides an example Graphical User Interface for establishing the notification option for a “Out of Range GFR” that was selected in the Wizard 316 of FIG. 20B. In the first selection menu window 348, a user is able to select the degree of severity for the out of range calculator. In this example, the user has selected “If Moderate” 350. When selected, an additional menu 352 is provided in which the user may set up additional logic that must be present to trigger the reporting option. In this example, if the degree is moderate as selected in window 348, window 352 sets at least two circumstances where reporting should be triggered: “Immediate Scheduled CT Scan With Contrast” 354 and “Future (greater than one week) Scheduled CT Scan With Contrast” 362, among others. When completed, the user will be taken to Graphical User Interface as shown in FIG. 22 from which the user can select the notification option that would occur if the logic set up in FIG. 21 occurs. In FIG. 22, the interface provides two notification options each of which provides a pull-down menu 356 of a notification type, a pull-down menu 358 of a notification target, and a pull-down menu 360 of a notification timing. In the present example the technologist will be paged immediately if a moderate out of range GFR result is present in a patient's medical record and an immediate CT scan with contrast is scheduled for that patient or a future (greater than 1 week) CT scan with contrast is scheduled for that patient. FIG. 23 provides an example of the set up of another reporting option: “email the ordering physician immediately.”

Referring back to FIG. 20B and the Wizard 316, another example of graphical interface that can be set up is when the user places the “Pathology Report Notification” option into window 344 another wizard will be activated as shown in FIG. 24. As shown in FIG. 24, the user is given several options for selecting notification mechanisms and destinations that are triggered when the pathology report is available. In the left-hand column are several activate/deactivate boxes 364, where the first activate box is “e-mail” notification method, the second box is a “page” notification method and the third box is an “instant message” notification and the right most column includes pull-down menus 366 associated with each notification method where the user can select the destination of the activated notification mechanism from column 364.

FIG. 25 shows an example graphical user interface wizard (“Follow-Up Wizard”) that allows the caregiver to set up follow-up examinations or other procedures as a result of an abnormal examination or task and as a result of a normal examination or task. A select procedure pull-down menu 367 allows a user to select the underlying or previous procedure, such as “Knee X-ray.” An “If Abnormal” selection window 368 is provided where the user can highlight and move certain events to the “Follow-Up Options for 1-Click Order” window 370. As shown in this example, the user has selected “MRI knee” and “Follow-up Appointment with Me” to be transferred into the “Follow Up Options for 1-Click Order” options window 370 if there is an abnormal knee x-ray. Below that window, the user is provided a Timing/Notification button 372 for the selected 1-click order events, which will bring up an interface as shown in FIG. 26 to select how soon the events are to take place in pull-down menu 374 and to provide the ability for user notification if the event does not occur within a given time as specified by pull-down menu 376, where the user's notification options can be set up in a user interface (similar to those shown in FIGS. 22 and 23, for example) brought forward upon the activation of button 378. Similar functionality allows the user to order follow-up additional tests in the event that the newly reported test result is normal. For example, in FIG. 25, the Follow-Up Wizard also provides an “If Normal” selection window 380 where the user can highlight and move certain events to the “Follow-Up Options for 1-Click Order” window 382. As shown in this example, the user has selected “MRI knee” to be transferred into the “One Click Order” options window if there is a normal knee x-ray. Below that window, the user is provided a Timing/Notification button 384 for the selected 1-click order events, which will bring up an interface as shown in FIG. 26, discussed above. In such an example, the normal report and images from the plain knee x-rays can be attached to the request for the MRI so that the radiologist interpreting the MRI is aware of the plain x-ray test results, and has access to the images for correlation when protocolling and/or interpreting the subsequent MRI.

As discussed above, various embodiments of the present invention provide macros allowing a caregiver to set up many types of trigger/notification scenarios for use in a healthcare facility. One of such scenarios discussed above concerns an ability to configure the embodiments of the present invention to, upon or during the scheduling of a magnetic resonance scan, automatically query the patient's accessible records to determine whether the patient has any implanted devices or other foreign bodies; and, if so, also automatically check to see whether any such objects have a risk of not being compatible with the magnetic fields generated during the MR scan. If such a risk is determined various automatic notifications may be established. FIG. 27 provides an example of graphical user interface for setting up such notifications. As shown in FIG. 27, notifications may be set up if the implanted device/foreign body in the patient is found in the master database to be incompatible with MR by activating Tab 390, and similar notification options may be set up if the implanted device/foreign body in the patient is found in the master database to be compatible with MR by activating Tab 392. In the example shown in FIG. 27, Tab 390 is active to set up the notification options if an MR incompatibility has been found in the database check. The first column of the notification set-up table has notification options for a first scenario of exams requested within a time frame determined by Pull-Down Menu 394 or a second scenario of exams scheduled within a time frame determined by Pull-Down Menu 396. Each scenario allows the user to set up a first notification recipient(s) in column 398, a second notification recipient(s) in column 400, and also allows the user to setup a trigger for notifying another recipient (or the same recipient) if one or more of the previous recipients have not been successfully notified in columns 402 and 404. Each of the notification columns include three pull-down menus: a first Pull-Down Menu 406 to select the recipient (or recipient group) of the notification, a second Pull-Down Menu 408 to indicate how the notification is to be sent (such as by email, instant-message, pop-up message, page, cell-phone/PDA call, cell-phone/PDA text message, and the like), and a third Pull-Down Menu 410 indicating the time frame for issuing such notification (immediately, 1-hour, 4-hours, 12-hours, 24-hours, 3 days, 1 week, 1 month, and the like).

As discussed above, certain embodiments of the present invention provide databases that include various implantable devices and other foreign objects which may be found in patients along with the relative susceptibility of such devices and/or objects to the magnetic fields of MR exams (or other types of scans or exams) for each item. Of course, this list or database will be updated periodically as new implantable devices and other objects (and their associated magnetic field susceptibility) become available. It is also within the scope of the invention that if an implanted device or other foreign object is not in such master database or list, the system can conduct a search of the internet for similar data or allow a user to conduct a manual search for such data. Referring back to FIG. 27, the graphical user interface shown provides a check box 412 in which an authorized user can select whether or not he/she wishes to conduct a manual search for such information if not found in the master database or list. The interface also provides similar notification options as discussed above 414 if the manual search is unsuccessful.

Having described the invention by reference to exemplary embodiments of the invention, it will be apparent to those of ordinary skill that it is possible to fall within the scope of the invention as defined, at least in part, by the following proposed points of novelty without necessarily practicing the exemplary embodiments of the invention. Likewise, it will be apparent to those of ordinary skill in the art that changes can be made to the exemplary embodiments of the invention without departing from the scope of the invention as envisioned in the following proposed points of novelty. It is also to be understood that the following proposed points of novelty are preliminary, and that additional points of novelty may exist even if not recited herein.

What is claimed is:

1. A computer implemented method for monitoring a healthcare information system comprising the steps of:
providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records;
logging into the medical information monitoring tool using a graphical user interface on the at least one user network interface device by an authorized user;
activating, by the authorized user via the graphical user interface, a medical information monitoring profile, the medical information monitoring profile including:
an identification of one or more medical information data items in the medical information data stores to access,
at least one notification trigger upon which one or more parties will be notified, an identity of one or more parties to notify, and
one or more notification mechanisms for notifying the one or more parties;
following the activation step, monitoring by the medical information monitoring tool at least one or more of the medical information data items identified in the medical information monitoring profile; and
automatically notifying the one or more parties identified in the medical information monitoring profile, via the one or more notification mechanisms included in the medical information monitoring profile, in automatic response to the at least one notification trigger being satisfied.

2. The computer implemented method of claim 1, wherein:
the medical information monitoring tool has access to a plurality of predefined medical information monitoring profiles; and
the activating step provides a choice to the authorized user, via the graphical user interface, to activate one or more of the predefined medical information monitoring profiles or to set up a custom medical information monitoring profile.

3. The computer implemented method of claim 2, wherein the plurality of predefined medical information monitoring profiles will be selected for the authorized user based upon the authorized user's roles within the healthcare facility.

4. The computer implemented method of claim 1, wherein the one or more medical information data items include one or more medical procedure reports.

5. The computer implemented method of claim 4, wherein the one or more medical information data items include at least a portion of a patient's medical record.

6. The computer implemented method of claim 4, wherein the one or more medical information data items include one or more medical test results.

7. The computer implemented method of claim 4, wherein the one or more medical information data items include one or more resource availability status of healthcare facility resources.

8. The computer implemented method of claim 7, wherein the availability status of healthcare facility resources are taken from a group consisting of: medical equipment availability, procedure room availability and medical personnel availability.

9. The computer implemented method of claim 1, wherein the at least one notification trigger is a check of whether a medical test result is outside of a predetermined range of values.

10. The computer implemented method of claim 1, wherein the at least one notification trigger is a determination of a risk to a patient developing contrast nephropathy.

11. The computer implemented method of claim 10, wherein the monitoring step occurs automatically in response to the patient being scheduled for an intravenous contrast procedure.

12. The computer implemented method of claim 10, wherein the at least one notification trigger is the result of an identification of, at least in part, a medical test result of the patient's creatinine level being outside of a predetermined range.

13. The computer implemented method of claim 10, wherein the at least one notification trigger is based upon, at least in part, a calculation of a patient's risk for contrast nephropathy, the calculation involving at least the patient's creatinine level.

14. The computer implemented method of claim 13, wherein the calculation further involves one or more of the following medical information data items: the patient's age, the patient's height, the patient having a diagnosis or history of diabetes, the patient having a diagnosis or history of cardiac disease, the patient having a diagnosis or history of heart failure, the patient having a diagnosis or history of hypotension, the patient having a diagnosis or history of dehydration, the patient having an existence or history of diuretic usage, the patient having a diagnosis or history of low hemoglobin, the patient having a diagnosis or history of low serum albumin, the patient having an existence of simultaneous use of certain medications toxic to the kidneys, and the patient having an existence of concurrent use of particular medications.

15. The computer implemented method of claim 10, wherein the at least one notification trigger is the result of, at least in part, an identification of a medical test result of the patient's creatinine level being outside of a predetermined range and the patient being scheduled for an intravenous contrast procedure.

16. The computer implemented method of claim 1, wherein the at least one notification trigger is the result of at least one Boolean operation performed on two or more of the medical information data items.

17. The computer implemented method of claim 1, wherein the at least one notification trigger is a determination related to the timing of a scheduled medical procedure.

18. The computer implemented method of claim 17, wherein the determination related to the timing of the scheduled medical procedure includes a calculation, either approximate or actual, of when the medical procedure will be available to start.

19. The computer implemented method of claim 18, wherein the calculation involves one or more of the following medical information data items: occurrence of a medical test result, scheduling of a medical test, availability of a medical facility, scheduling for a medical facility, availability of one or more pieces of medical equipment, scheduling of one or more pieces of medical equipment, availability of one or more medical personnel, and the scheduling of one or more medical personnel.

20. The computer implemented method of claim 19, wherein the scheduled medical procedure is a surgery.

21. The computer implemented method of claim 20, wherein the notification includes a notification to a surgeon of an approximate surgery start time.

22. The computer implemented method of claim 1, wherein the at least one notification trigger is in response to a scheduling of a radiation-based diagnostic test or therapy.

23. The computer implemented method of claim 22, wherein the notification includes a calculation or an approximation of a patient's lifetime radiation exposure.

24. The computer implemented method of claim 23, wherein the notification is body-part specific.

25. A computer implemented method for monitoring a healthcare information system for risks of contrast nephropathy comprising the steps of:
providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records;
scheduling a medical procedure involving intravenous contrast for a patient by an authorized user utilizing the at least one user network interface;
determining, by the medical information monitoring tool from information accessed in the medical information data stores, a risk for contrast nephropathy with the patient; and
automatically transmitting a notification regarding the determined risk to one or more medical system personnel.

26. The computer implemented method of claim 25, wherein the notification step is performed in response to the determined risk being at or above a predetermined threshold.

27. The computer implemented method of claim 25, wherein the determining step involves an identification of, at least in part, a medical test result of the patient's creatinine level being outside of a predetermined range.

28. The computer implemented method of claim 25, wherein the determining step involves a calculation of at least the patient's glomerular filtration rate (GFR).

29. The computer implemented method of claim 28, wherein the calculation further involves one or more of the following medical information data items: the patient's age, the patient's height, the patient having a diagnosis or history of diabetes, the patient having a diagnosis or history of cardiac disease, the patient having a diagnosis or history of heart failure, the patient having a diagnosis or history of abnormal blood pressure, the patient having a diagnosis or history of dehydration, the patient having an existence or history of diuretic usage, the patient having a diagnosis or history of low hemoglobin, the patient having a diagnosis or history of low serum albumin, the patient having an existence of simultaneous use of certain medications toxic to the kidneys, and the patient having an existence of concurrent use of particular medications.

30. The computer implemented method of claim 25, wherein the determining step involves an identification of a medical test result of the patient's creatinine level being outside of a predetermined range and the patient being scheduled for an intravenous contrast procedure.

31. A computer implemented method for monitoring a healthcare information system medical procedure schedule comprising the steps of:
providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including one or more of healthcare institution medical procedure schedules, healthcare institution medical facility availability information, healthcare institution medical equipment availability, healthcare institution medical personnel availability and healthcare institution medical test result information;
scheduling a medical procedure for the medical institution for a scheduled start time;
determining, by the medical information monitoring tool from information accessed in the medical information data stores at least one of: (a) whether or not the scheduled medical procedure will be likely to start at the scheduled start time, (b) an estimated actual start time for the scheduled medical procedure, and (c) at least one factor presently interfering with an ability for the scheduled medical procedure to start at the scheduled start time; and
automatically transmitting a notification regarding a result of the determining step to one or more medical system personnel.

32. The computer implemented method of claim 31, wherein the medical information data stores include at least a portion of a patient's medical record and the determining step is based upon, at least in part, information present or not present in the portion of the patient's medical record.

33. The computer implemented method of claim 31, wherein the medical information data stores include one or more medical test results, and the determining step is based upon, at least in part, the one or more medical test results.

34. The computer implemented method of claim 31, wherein the medical information data stores include one or more resource availability status of healthcare facility resources, and the determining step is based upon, at least in part, the status of at least one healthcare facility resource.

35. The computer implemented method of claim 34, wherein the availability status of healthcare facility resources are taken from a group consisting of: medical equipment availability, procedure room availability and medical personnel availability.

36. The computer implemented method of claim 31, wherein the scheduled medical procedure is a surgery.

37. The computer implemented method of claim 36, wherein the notification includes a notification to a surgeon of an approximate time prior to the determined surgery start time.

38. A computer implemented method for monitoring a healthcare information system for risks of radiation exposure comprising the steps of:
providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records;
at least one of (a) initiating a scheduling of and (b) scheduling a radiation-based diagnostic test or therapy for a patient by an authorized user utilizing the at least one user network interface;
determining, by the medical information monitoring tool from information accessed in the medical information data stores, a radiation exposure risk for the patient; and
automatically transmitting a notification regarding the determined radiation exposure risk to one or more medical system personnel.

39. The computer implemented method of claim 38, wherein the determination includes a calculation or an approximation of a patient's lifetime radiation exposure.

40. The computer implemented method of claim 39, wherein the determination is body-part specific.

41. A computer implemented method for monitoring a healthcare information system to determine whether a patient, who has an implanted device or a foreign body that may be incompatible with a magnetic resonance scanner's magnetic field, is at an increased risk of injury if placed in a magnetic resonance scanner's magnetic field, the method comprising the steps of:
providing a medical information system including a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records;
scheduling a medical procedure involving a magnetic resonance scan for a patient by an authorized user utilizing the at least one user network interface;
determining, by the medical information monitoring tool from information accessed in the medical information data stores, a risk to a patient having at least one of an implanted device and a foreign body at least partially incompatible with a magnetic field generated by a magnetic resonance scanner; and
automatically transmitting a notification regarding the determined risk to one or more medical system personnel.

42. The computer implemented method of claim 41, wherein the determining step determines from the accessed medical information data stores whether the patient has at least one of an implanted device and a foreign body.

43. The computer implemented method of claim 42, wherein the determining step further determines from the accessed medical information whether the at least one implanted device and foreign body has at least one of an actual incompatibility with a magnetic field generated by a magnetic resonance scanner and a potential incompatibility with a magnetic field generated by a magnetic resonance scanner.

44. The computer implemented method of claim 41, wherein the transmitting step occurs only upon a determined risk being above a predetermined threshold.

45. The computer implemented method of claim 41, wherein the determined risk is at least the determined presence of at least one of an implanted device and a foreign body in the patient.

46. The computer implemented method of claim 41, wherein the notification is transmitted to the authorized user in the same session in which the user scheduled the medical procedure.

47. The computer implemented method of claim 46, wherein the notification is within a pop-up window.

48. The computer implemented method of claim 41, wherein the notification includes a limit to the magnetic field that can be used with the at least one implanted device and foreign body.

49. The computer implemented method of claim 41, wherein the determining step is performed in automatic response to the scheduling step.

50. The computer implemented method of claim 41, wherein the determined risk is at least the determined presence of a certain data item on the patient's medical record.

51. A medical information system comprising a computer server having access to one or more medical information data stores and operating at least a portion of a medical information monitoring tool, and including at least one user network interface device operatively coupled for communication with the computer server over a computer network or integrated with the computer server, the medical information data stores including a plurality of patient medical records;
the system being configured to allow an authorized user to activate, via a graphical user interface operating on the user network interface device, a medical information monitoring profile, the medical information monitoring profile including:
an identification of one or more medical information data items in the medical information data stores to access,
at least one notification trigger upon which one or more parties will be notified, an identity of one or more parties to notify, and
one or more notification mechanisms for notifying the one or more parties;
the system being further configured to monitor at least one or more of the medical information data items identified in the medical information monitoring profile; and
the system being further configured to automatically notify the one or more parties identified in the medical information monitoring profile, via the one or more notification mechanisms included in the medical information monitoring profile, in automatic response to the at least one notification trigger being satisfied.
